(19) United States
(12) Patent Application Publication
(10) Pub. No.: US 2026/0208184 A1
(43) Pub. Date: Jul. 23, 2026

(54) SAMPLE COLLECTION AND ANALYSIS SYSTEM

(71) Applicant: 3M INNOVATIVE PROPERTIES COMPANY, St. Paul, MN (US)

(72) Inventors: Michael C. Wohl, Bethesda, MD (US); Tonya D. Bonilla, Woodbury, MN (US); Audrey A. Sherman, Woodbury, MN (US); Michael R. Berrigan, Oakdale, MN (US); Narina Y. Stepanova, Woodbury, MN (US)

(21) Appl. No.: 19/137,807

(22) PCT Filed: Dec. 15, 2023
(86) PCT No.: PCT/IB2023/062735

§ 371 Date: Jun. 11, 2025

Related U.S. Application Data
(60) Provisional application No. 63/433,314, filed on Dec. 16, 2022.

(51) Int. Cl. B01L 3/00; B01L 7/00

(52) U.S. Cl. CPC B01L 3/5023; B01L 7/52; B01L 2200/16; B01L 2300/0681; B01L 2300/069; B01L 2300/1816; B01L 2300/1827

(57) ABSTRACT

A sample collection and analysis system includes porous sample collection media; a liquid reservoir containing a liquid; a reagent composition; and a housing including: a heatable reaction zone; and a heating system operably coupled with the heatable reaction zone. The heating system may be constructed to heat the porous sample collection media and at least a portion of the reagent composition in the heatable reaction zone to a predetermined temperature of 37° C. to 70° C. The reagent composition may include a loop-mediated isothermal amplification (LAMP) reagent.

### BACKGROUND

Diagnostic tests used to test for the presence of a virus or other pathogen in the airways, throat, or nasopharynx typically involve the insertion of a swab into the back of the nasal passage, the mid-turbinate area of the nasal passage, the anterior nares, or the throat to obtain a sample. The swab is then inserted into a container and analyzed or sent to a lab for processing. Other diagnostic tests involve collecting a saliva sample and then placing it in a container.

Recently, an unprecedented need for rapid viral testing has arisen due to the COVID-19 pandemic. Attempts to control the pandemic has required a massive expansion of testing for SARS-CoV-2 virus in several different clinical and epidemiological contexts. Until recently, nasopharyngeal (NP) swabs were the United States Centers for Disease Control and Prevention's (CDC) preferred specimen type, as these specimens were thought to provide the most robust detection of patient infection. However, there are conflicting reports as to which of several specimen types bear the highest viral load.

Sensitivity is a complex issue, however, as detection in the upper airways (nasopharynx and oropharynx) is affected by multiple factors including duration of illness prior to testing, as well as the limit of detection (LoD) of the RT-PCR assay used. Availability of NP swabs and the resources to establish NP collection sites with specimen collection personnel have remained critical bottlenecks. To resolve these issues, healthcare systems have adopted multiple different strategies, including engaging industrial manufacturers to mass produce novel 3D-printed NP swabs, as well as evaluating different specimen types and alternative sample-collection strategies, such as saliva. Assessment of nasal swabs and saliva is a rapidly growing area of interest, specifically because these specimen sample type involves a less invasive procedure than NP swabs.

Accordingly, such samples can be self-collected by patients with a simple set of instructions, alleviating the need for highly trained medical personnel for specimen collection.

Many of the US Food and Drug Administration Emergency Use Authorization (FDA EUA) RT-PCR assays have approval for use of nasal swabs as a specimen type as well as saliva, but how well these samples perform compared to NP swabs remains unclear. To date, nasal-swab studies have shown conflicting results, with some researchers reporting similar test performance to NP swabs and others finding decreased sensitivity.

Currently available at-home viral tests (e.g., COVID-19 tests) involve a nasal swab and a test kit (for example, the Ellume™ test, the Abbot™ BinaxNOW™ test, and the Lucira™ All-in-One test kit). Tests that utilize nasal swab samples or saliva contend with contaminants that can interfere with the various diagnostic tests. As a result, these sample types require a purification step when using RT-PCR molecular testing.

### SUMMARY

There is a need for an inexpensive, simple to use, and reliable sample collection and analysis system that may be used by laypeople for testing for the presence of a target virus, target pathogen, or other target analyte, in a collected sample. The sample collection and analysis system may include a sample collection device for collecting a sample from exhalation airflow and a testing assay to determine the presence or absence of virus or other pathogen in the collected sample.

It is desirable to provide a system that includes both a sample collector device and rapid antigen testing in an integrated system. The integrated system may advantageously be self-contained and optionally sterile. A self-contained and sterile system may improve accuracy and reliability of pathogen testing due to the reduced contamination and background noise, unlike swabs and other test collection devices which may be contaminated upon use and/or during testing.

It is further desirable to provide a system which, after sample collection and optional testing, remains closed and self-contained to contain any potential virus or pathogen, and which may be safely disposed of among ordinary waste collection.

A sample collection and analysis system includes porous sample collection media; a liquid reservoir containing a liquid; a reagent composition; and a housing including: a heatable reaction zone; and a heating system operably coupled with the heatable reaction zone. The heating system may be constructed to heat the porous sample collection media and at least a portion of the reagent composition in the heatable reaction zone to a predetermined temperature of 37° C. to 70° C. The predetermined temperature may be from 60° C. to 70° C. The heating system may be constructed to maintain the predetermined temperature for 5 minutes or longer.

The reagent composition may include a loop-mediated isothermal amplification (LAMP) reagent. The reagent composition may include a buffer, polymerase enzyme, nucleotides, and salts. The buffer may include tris(hydroxymethyl)aminomethane, potassium acetate, magnesium acetate, tris-acetate, or a combination thereof. The polymerase enzyme may include a Bst DNA polymerase.

The nucleotides include dNTPs. The salt may include magnesium chloride, magnesium sulfate, potassium chloride, ammonium sulfate, or a combination thereof. The reagent composition may include tris(hydroxymethyl)aminomethane, Bst DNA polymerase, dNTPs, magnesium sulfate, potassium chloride, ammonium sulfate, and a dye. The reagent composition may include DNA primers. The DNA primers may have an annealing temperature (T_{A}) of 50° C. to 60° C. The reagent composition may include a detergent, optionally wherein the detergent may include Triton X-100.

The porous sample collection media may be disposed within the housing. The housing may include an air inlet constructed to receive an exhalation airflow and an airflow path extending from the air inlet through the porous sample collection media. The sample collection and analysis system further including a pre-filter fixed within the housing and along the airflow path and between the air inlet and the porous sample collection media.

The housing may include the liquid reservoir in fluid communication with the porous sample collection media, constructed to direct liquid onto the porous sample collection media, the liquid reservoir including a volume housing the liquid; and a release mechanism for releasing the liquid from the liquid reservoir. The release mechanism may include a breakable membrane. The release mechanism may include a removable tab sealing an opening of the liquid reservoir.

The heatable reaction zone may include the porous sample collection media and may be constructed to receive at least a portion of the liquid and the reagent composition.

The housing may include an assay constructed to receive a reaction mixture from the porous sample collection media. The assay may be constructed to detect presence of a virus, other pathogen, or other analyte in the reaction mixture. The assay may be a lateral flow assay, a vertical flow assay, or a colorimetric indicator. The housing may include a test result display window. The sample collection and analysis system further including a colorimeter.

The heating system may include a resistive heating element or inductive heating element.

The reagent composition may include a first liquid reagent and a second liquid reagent. The first liquid reagent may include buffer, polymerase enzyme, nucleotides, and salts. The first liquid reagent may include tris(hydroxymethyl)aminomethane, Bst DNA polymerase, dNTPs, magnesium chloride, magnesium sulfate, potassium chloride, ammonium sulfate, and a dye. The second liquid reagent may include DNA primers. The liquid reservoir may contain the reagent composition. The first liquid reagent may be contained in a first compartment of the liquid reservoir and the second liquid reagent may be contained in a second compartment of the liquid reservoir. The may further include a third liquid reagent. The third liquid reagent may include a detergent, such as Triton X-100. The third liquid reagent may be applied before the first liquid reagent and the second liquid reagent.

The reagent composition may include a dry lyophilized mixture. The dry lyophilized mixture may include a buffer, polymerase enzyme, nucleotides, salts, DNA primers, a dye, and an excipient. The reagent and the liquid may be configured for mixing into a liquid reagent.

The liquid may have a volume in a range of 50 μL to 1000 μL.

The porous sample collection media may include a nonwoven filtration layer having an electrostatic charge. The nonwoven filtration layer may be hydrophobic.

A method of collecting and testing a sample includes flowing exhalation air through a porous sample collection media to form a captured sample; releasing a metered dose of liquid from a liquid reservoir and a reagent composition onto the captured sample; activating a heating system to heat the captured sample, the metered dose of liquid, and the reagent composition to a predetermined temperature of 37° C. to 70° C.; and observing a test result. The reagent composition may be mixed with the metered dose of liquid within the liquid reservoir. The reagent composition may be a dry powder and may be mixed with the metered dose of liquid upon releasing of the metered dose of liquid and the reagent composition. The reagent composition may include a first portion and a second portion and wherein the releasing of the reagent composition may include mixing the first and the second portions. Flowing exhalation air through the porous sample collection media may include exhaling through a mouthpiece or a nosepiece.

The method may include reading the test result from the assay including an indicator of a presence of a virus, other pathogen, or other analyte in the reaction mixture. The method may include reading the test result using a colorimeter. Observing of the test result may include observing a positive result if a target virus or other target pathogen may be present or negative result if a target virus or other target pathogen may be absent. The heating may include using a resistive heating element or inductive heating element.

The instructions may further include instructions to read a test result display of the assay using an electronic reader.

### BRIEF DESCRIPTION OF FIGURES

FIG. 1 is a listing of sequence IDs used in the Examples.

FIG. 2 shows photographic images of samples in Example 1.

FIG. 3 shows photographic images of samples in Example 2.

FIGS. 4A-4C show photographic images of samples in Example 3.

FIG. 5 shows photographic images of samples in Example 4.

FIGS. 6A and 6B are amplification schematics.

FIG. 7 is a schematic depiction of a sample collection and analysis system according to an embodiment.

FIGS. 8A-8E are schematic depiction of sample collection and analysis systems according to embodiments.

FIG. 8F is a schematic depiction of a heating system of the sample collection and analysis system of FIGS. 7-8E.

FIG. 9 is a schematic perspective view of a sample collection and analysis system according to an embodiment.

FIG. 10A is a schematic plan view of a sample collection device in an unfolded configuration according to an embodiment.

FIG. 10B is a schematic perspective view of a sample collection and analysis system including the sample collection device of FIG. 10A in a folded configuration.

FIG. 11A is a schematic side view of a sample collection and analysis system according to an embodiment.

FIG. 11B is a schematic side and perspective view of the sample collection and analysis system of FIG. 11A and an assay according to an embodiment.

FIG. 12A is a schematic perspective view of a sample collection and analysis system according to an embodiment.

FIG. 12B is a schematic side view of the sample collection and analysis system of FIG. 12A.

FIG. 13A is a schematic perspective view of a sample collection and analysis system according to an embodiment.

FIG. 13B is a cross-sectional side view of an exemplary mouthpiece for the sample collection and analysis system of FIG. 13A.

FIG. 14A is a schematic perspective view of a sample collection device in a partially open configuration according to an embodiment.

FIG. 14B is a cross-sectional perspective view of a sample collection and analysis system including the sample collection device of FIG. 14A in a closed configuration.

FIG. 15A is a schematic perspective view of a sample collection and analysis system in an open configuration according to an embodiment.

FIG. 15B is a schematic perspective view of the sample collection and analysis system of FIG. 15A in a partially closed (folded) configuration.

FIG. 15C is a schematic perspective view of the sample collection and analysis system of FIG. 15A in a fully closed (folded) configuration.

FIG. 16A is a top view of a sample collection and analysis system according to an embodiment.

FIG. 16B is a cross-sectional side view of the sample collection and analysis system of FIG. 16A.

FIG. 16C is a cut-away perspective view of the mouthpiece and liquid reservoir of the sample collection and analysis system of FIG. 16A.

FIG. 17A is a schematic perspective view of an amplification system for a sample collection and analysis system according to an embodiment.

FIG. 17B is a partial view of the amplification system of FIG. 17A showing heating elements.

FIG. 18 is a schematic side view of a sample collection and analysis system according to an embodiment.

FIG. 19A is a schematic side view of a sample collection and analysis system in an open configuration according to an embodiment.

FIG. 19B is a schematic side view of the sample collection and analysis system of FIG. 19A in a closed configuration.

FIG. 19C is a schematic top view of the sample collection and analysis system of FIG. 19A in a closed configuration.

FIG. 19D is a schematic side view of the sample collection and analysis system of FIG. 19A further including additional layers.

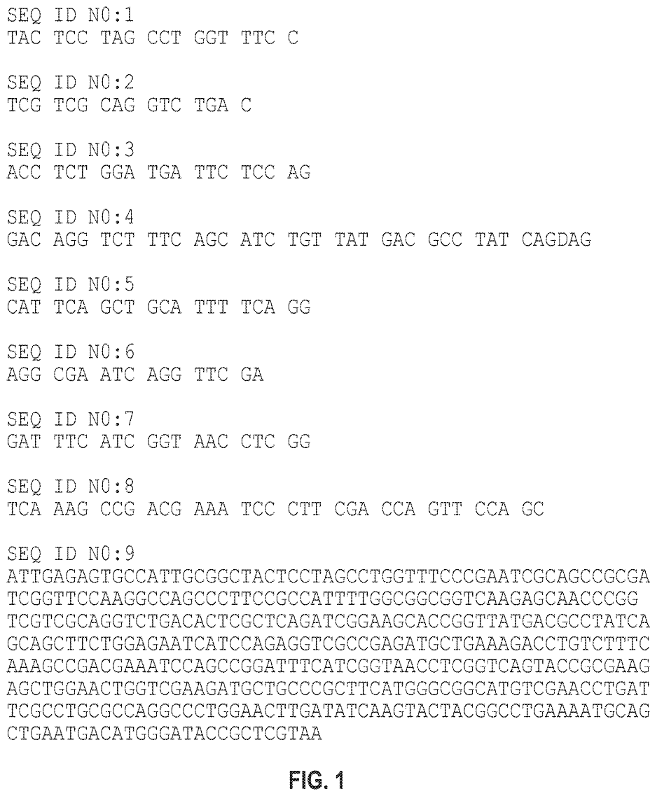

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

All headings provided herein are for the convenience of the reader and should not be used to limit the meaning of any text that follows the heading, unless so specified.

The term “i.e.” is used here as an abbreviation for the Latin phrase id est, and means “that is,” while “e.g.” is used as an abbreviation for the Latin phrase exempli gratia and means “for example.”

The term “about” is used here in conjunction with numeric values to include normal variations in measurements as expected by persons skilled in the art and is understood have the same meaning as “approximately” and to cover a typical margin of error, such as +5% of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have”, “having”, “include”, “including”, “comprise”, “comprising” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method or the like, means that the components of the composition, product, method or the like are limited to the enumerated components and any other components that do not materially affect the basic and novel characteristic(s) of the composition, product, method or the like.

The term “substantially” as used here has the same meaning as “significantly,” and can be understood to modify the term that follows by at least about 90%, at least about 95%, or at least about 98%. The term “not substantially” as used here has the same meaning as “not significantly,” and can be understood to have the inverse meaning of “substantially,” i.e., modifying the term that follows by not more than 10%, not more than 5%, or not more than 2%.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Any direction referred to here, such as “front,” “back,” “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

The terms “downstream” and “upstream” refer to a relative position based on a direction of exhalation airflow through the device. For example, the upstream-most element of the device is the air inlet element, and the downstream-most element of the device is the exhalation outlet element.

### DETAILED DESCRIPTION

There is a need for a simple, clean sample collection and analysis system and easy testing of samples. Further, there is a need for a sample collection and analysis system that can also capture and elute samples that have a low pathogen (e.g., viral) load but are still capable of transmitting the pathogen (e.g., virus) to others. There is a need for a sample collection and analysis system that is capable of early detection of a pathogen (e.g., virus). There is also a need for a more precise system to reduce human error and provide more repeatable a reliable test results.

The present disclosure relates to a sample collection and analysis system. The present disclosure relates to a bioaerosol collection device. The present disclosure provides a system capable of amplifying a sample signal. The present disclosure further relates to a system that includes both sample collection and testing capabilities.

The sample collection and analysis system of the present disclosure includes porous sample collection media, a liquid reservoir containing a liquid, a reagent composition, and a housing with a heatable reaction zone and a heating system operably coupled with the heatable reaction zone. The liquid reservoir, the reagent composition, the heatable reaction zone, and the heating system collectively form an amplification system. The system is configured to amplify a sample collected in the porous sample collection media.

The reagent composition and liquid may be applied onto the loaded porous sample collection media. The liquid may travel into and through the surface and thickness of the loaded porous sample collection media. The heating system may heat the reagent composition, liquid, and porous sample collection media. The reagent composition may react with any target analytes present in the porous sample collection media. A result may be observed visually or by using an instrument, such as a colorimeter. The reaction mixture, which may include amplified target analytes, may be transferred off of the porous sample collection media onto an assay and tested for the presence of the amplified target analyte.

The system may be configured as a single integrated device. Such a single integrated device may include a sample collection device, the amplification system, and an assay for analyzing a sample. Alternatively, one or more of the parts of the system may be provided as separate items.

The system may optionally include a device for collecting the sample. The porous sample collection media may be housed within the device. The sample collection device may be integral with the amplification system. Alternatively, the sample collection device may be separate from the amplification system. The sample may be loaded onto the porous sample collection media separately (e.g., by using a separate sample collection device), and the porous sample collection with the loaded sample may be placed within the housing of the system.

The system may optionally include an assay for receiving the amplified sample from the amplification system. The assay may further be configured to analyze the analyte of interest. The assay may be configured to detect a nucleic acid from the analyte of interest. The assay may be integral with the amplification system. The assay may further be integral with the sample collection device. The assay may form a unitary element with the housing of the amplification system.

Any analyte of interest including a nucleic acid may be suitable for detecting using the assays described herein. Typically, the nucleic acid is present in the sample upon application to the assay, e.g., upon application to the porous sample collection media. In some embodiments, the nucleic acid may be accessible, e.g., not enclosed within a lipid or protein compartment such as a cell membrane or viral capsid. In some embodiments the nucleic acid may be accessible when the reagent liquid reaches the collected sample.

The analyte of interest may be a virus, bacteria, fungus, pathogen, or other analyte. In embodiments where the analyte of interest is a virus, it may be enveloped or non-enveloped. The virus may be a coronavirus, rhinovirus, norovirus, influenza virus, adenovirus, adeno-associated virus, varicella-zoster virus, herpesvirus, retrovirus, papillomavirus, enterovirus, arenavirus, or another type of virus. In some embodiments, the virus is present in an aerosol sample. In embodiments wherein the analyte of interest is a coronavirus, it may be COVID-19.

In some embodiments, the analyte of interest is a bacteria. The bacteria may be, for example, Mycobacterium tuberculosis, Streptococcus pneumoniae, Mycoplasma pneumoniae, Haemophilus influenzae, Chlamydophila pneumoniae, Coxiella burnetiid, Moraxella catarrhalis, Histoplasma capsulatum, or Legionella pneumophila.

In some embodiments, the analyte of interest is a fungus. The fungus may be, for example, Cryptococcus neoformans, Aspergillus, Pneumocystis, or endemic fungi.

According to an embodiment, the amplification system utilizes polymerase chain reaction (“PCR”) to amplify a nucleic acid in the sample. In some embodiments, the PCR method may be isothermal, meaning that it takes place primarily at one temperature. Isothermal PCR methods include loop-mediated isothermal amplification (LAMP), nucleic acid sequence based amplification (NASBA), helicase-dependent amplification (HDA), rolling circle amplification (RCA), multiple displacement amplification (MDA) and recombinase polymerase amplification (RPA). In some embodiments, the PCR method is LAMP.

The reagent composition may therefore include PCR reagents, or more specifically LAMP reagents. Generally, the reagents include polymerase enzyme, nucleotides, DNA primers, one or more salts, and a buffer. The reagents may also include additional components, such as a dye, sugar, sugar alcohols, polyols, polymers, surfactants, chelating complexes, molecular crowding agents, ATP, scavenger DNA, detergents or surfactants (e.g., Tween 20), additional enzymes (e.g., uracil deglycosylase), or proteins (e.g., albumin). The reagents may include any chemicals known to enhance PCR, including glycerol, dithiothreitol (DTT), trimethylglycine (also called betaine), dimethyl sulfoxide (DMSO), formamide, tetramethylammonium chloride (TMAC), or a combination thereof.

The polymerase may be any suitable polymerase with strand displacement activity. The polymerase may be, for example, Bst DNA polymerase, or phi29 DNA polymerase. Suitable polymerases include, but are not limited to, Bst 3.0 DNA polymerase, Bst 2.0 DNA polymerase, Bst 2.0 WARMSTART DNA polymerase (available from New England Biolabs in Ipswich, MA), or full length Bst DNA polymerase.

The nucleotides may include, for example, deoxyribonucleotide triphosphates (“dNTPs”). The nucleotides may include deoxyadenosine triphosphate, deoxycytidine triphosphate, deoxyguanosine triphosphate, and deoxythymidine triphosphate. In some embodiments, the nucleotides may include deoxyuridine triphosphate. The nucleotides may be provided in an equimolar ratio. Alternatively, certain nucleotides may be provided at greater concentrations. In particular, deoxythymidine triphosphate may be provided in a lower amount relative to other provided nucleotides, and deoxycytidine triphosphate and/or deoxyguanosine triphosphate may be provided in a relatively higher amount. In some embodiments, the reaction may include at least 0.1 millimolar (mM), at least 0.2 mM, at least 0.4 mM, at least 0.5 mM, at least 0.6 mM, at least 0.7 mM, at least 0.8 mM, at least 0.9 mM, or at least 1.0 mM of total nucleotides. In some embodiments, the reaction may include at most 6 mM, at most 4 mM, at most 2 mM, at most 1 mM, or at most 0.5 mM of total nucleotides.

The region of the target nucleic acid amplified by the systems described herein may be referred to as the “amplicon”. The amplicon may be selected for any combination of characteristics, such as GC-content, secondary structure, similarity to related analyte, such as a virus or pathogen, or how conserved a particular sequence is within a species. Typically, the amplicon includes between 100 nucleotides (nt) and 600 nt, such as between 200 nt and 400 nt. The amplicon may include 100 nt or more, 150 nt or more, 200 nt or more, 250 nt or more, 300 nt or more, 350 nt or more, or 400 nt or more. The amplicon may include 600 nt or less, 500 nt or less, 400 nt or less, or 300 nt or less.

The amplicon is typically amplified using a combination of short, single-stranded nucleic acids called “primers.” Using traditional PCR methods, one strand of an amplicon is amplified at a time using a single primer. Alternative PCR methods such as LAMP may amplify one strand of an amplicon with multiple primers simultaneously. In some embodiments, the primers may include non-nucleotide moieties. For example, one or more primers may include a biotin moiety or a fluorophore.

In some embodiments, the primers are configured to enable amplification of an amplicon using a polymerase. Primers may be designed according to standard molecular biology practices. Briefly, a primer may be designed to have a specific melting temperature (T_{M}), annealing temperature (T_{A}), or G/C content. The orientation of a primer may depend on the polymerase used. Most polymerases amplify a template 3′ to 5′, thus, the newly synthesized strand is typically synthesized 5′ to 3′. A primer may bind to the 3′ end of a nucleic acid. The primer may be extended from the 3′ end of the primer by the polymerase. In some embodiments, primers may include additional nucleotides on the 5′ end. The additional nucleotides may be identical to a region of the amplicon.

In some embodiments, a primer may have a T_{A} of 50° C. or less, 52° C. or less, 54° C. or less, 56° C. or less, 58° C. or less, 60° C. or less, 62° C. or less, 64° C. or less, 66° C. or less, 68° C. or less, or 70° C. or less. A primer may have a T_{A} of 40° C. or more, 42° C. or more, 44° C. or more, 46° C. or more, 48° C. or more, 50° C. or more, 52° C. or more, or 54° C. or more. For example, a primer may have a T_{A} of 40° C. to 70° C., such as 50° C. to 60° C. or 55° C. In some embodiments wherein multiple primers are used, each primer may have the same T_{A}. In some embodiments wherein multiple primers are used, the T_{A} of each primer may be independently selected. The T_{A} of all primers used may be within, for example, 10° C., within 8° C., within 6° C., within 4° C., or within 2° C.

Traditional PCR primer design typically includes two primers which bind to the 5′ end of each strand of the amplicon. For example, a first primer may bind to the sense strand of a gene, and a second primer may bind to the antisense strand of a gene. The double-stranded region of the gene between the two primers may be the amplicon.

Primer design for LAMP differs from traditional PCR primer design. LAMP reactions typically include either four or six primers. A first set of primers amplify the amplicon similarly to a pair of traditional PCR primers. These primers are referred to as the “F3” and the “B3” primers. The F3 primer binds the 3′ end of the sense strand of the amplicon. The B3 primer binds the 3′ end of the antisense strand of the amplicon. This amplification typically provides additional copies of the amplicon for amplification using the forward internal primer and backward internal primer, described in more detail herein.

A second pair of primers amplify the amplicon and add 3′ and 5′ loops. A first primer, referred to as a “forward internal primer” binds to a first portion of an amplicon (F2c). The forward internal primer typically includes a region on the 5′ end which is identical to a second portion of the amplicon (F1c). A second primer, referred to as a “backward internal primer” is identical to a third portion of the amplicon (B2) and includes a region on the 5′ end complementary to a fourth portion of the amplicon (B1). The amplicon may first be amplified 3′ to 5′ using the forward internal primer. The product of this amplification may then be amplified using the backward internal primer to produce a single-stranded structure with 3′ and 5′ loops.

An additional pair of primers referred to as the “Loop F” and “Loop B” primers each bind in one of the loops. The Loop F and Loop B primers are not required for LAMP, but typically improve sample detection and increase the rate of amplification.

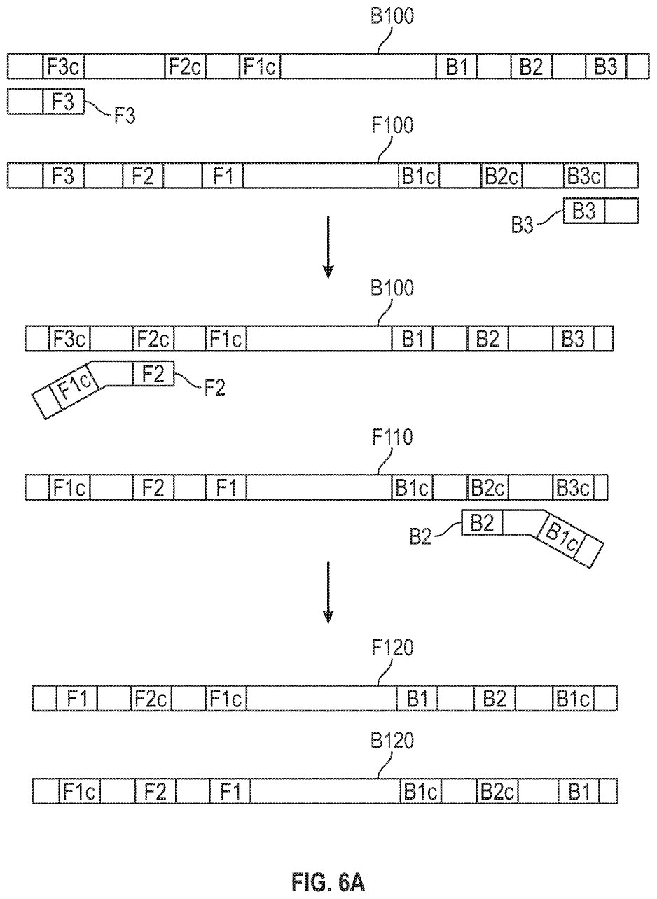

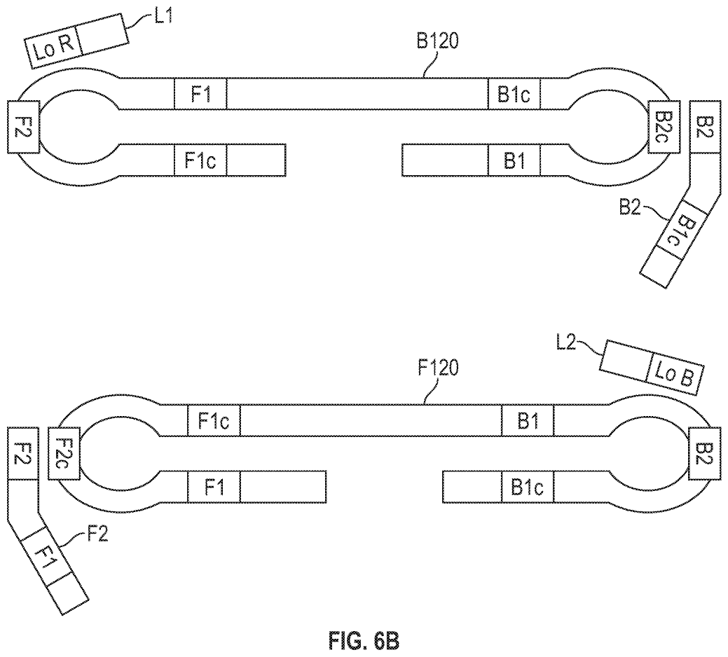

The amplification is further demonstrated in FIGS. 6A and 6B. In FIG. 6A, primers F100 and B100 can be used to amplify both strands of the original linear template. As shown here, primer F3 amplifies the B-strand (B100) to yield the F-strand (F100). Primer B3 amplifies the F strand (F100) to yield the B-strand (B100). Primer F3 binds to the F3c site of the B-strand (B100). Primer B3 binds to the B3c site of the F-strand (F100).

Primer F2 binds to site F2c on the B-strand (B100). Primer F2 additionally includes at its 5′ end the F1c sequence. Primer F2 can be used to amplify the B-strand to yield strand F110. Primer B2 binds to the B2c site on strand F110. Primer B2 can be used to amplify strand F110 to yield strand F120.

Alternately, strand F100 can be amplified first with primer B2, then with primer F2 to yield strand B120. Strands F120 and B120 will each form a double-hairpin structure through the complementarity of F1/F1c and B1/B1c as shown in FIG. 6B.

In FIG. 6B, hairpin B120 (top) can be amplified using primer B2 to yield hairpin F120 (bottom). Primer F2 can be used to amplify hairpin F120 to yield loop B120. This amplification may continue to yield exponential generation of both hairpins. Optionally, loop primer LoR (L1) can be used to additionally amplify a portion of B120. Optionally, loop primer LoB (L2) can be used to amplify a portion of F120.

The primers used may change depending on the target to be detected and the amplification method used. The reaction may include any number of primers, such as two, three, four, five, six, seven, or eight primers. Primers may be obtained from any suitable source and may be used at any suitable concentration. The concentration of each primer may be 10 nanomolar (nM) or greater, 50 nM or greater, 100 nM or greater, 200 nM or greater, 400 nM or greater, 500 nM or greater, 1 micromolar (μM) or greater, 2 μM or greater, or 3 μM or greater. The concentration of each primer may be 5 μM or less, 4 μM or less, 3 μM or less, 2 μM or less, 1 μM or less, or 500 nm or less. The total concentration of all primers in a given composition may be 1 μM to 20 μM, such as 4 μM to 10 μM.

The reaction may include components to prepare a pH-buffered solution. The buffering components may include, for example, tris(hydroxymethyl)aminomethane (“tris”), potassium acetate, magnesium acetate, or tris-acetate. The buffer may include at least 10 mM, at least 15 mM, at least 20 mM, at least 30 mM, at least 40 mM, at least 50 mM, at least 60 mM, at least 80 mM, at least 100 mM, or at least 150 mM of buffering components. The buffer may include at most 500 mM, at most 400 mM, at most 200 mM, at most 100 mM, at most 60 mM, or at most 40 mM of buffering components.

Nucleic acid amplification frequently benefits from the presence of dissolved metal ions, particularly divalent metal cations such as Mg²⁺. The reaction may include one or more salts. The one or more salts may include, for example, magnesium chloride, magnesium sulfate, potassium chloride, ammonium sulfate, manganese chloride, or the like.

The dye used may detect increased target abundance in any suitable way, such as detection of a specific sequence, intercalation in formed double-stranded DNA, or change in pH. The dye may be fluorescent or colorimetric. Dyes which detect a change in pH may include, for example, phenol red, bromothymol blue, phenolphthalein, naphtholphthalein, chlorophenol red, dichloro fluoroscein, methyl orange, cresol purple, cresol red, and cresolphthalein. Alternatively or additionally, a universal pH indicator may be used. Dyes which intercalate in DNA may include, for example, SYBR green, SYBR gold, SYBR safe, and ethidium bromide. Reagents which detect a specific sequence may include, for example, molecular beacons or strand displacement probes. Typically, these type of reagents include a fluorescent or colorimetric moiety that is masked by a quencher until the reagent detects and binds a specific target sequence.

The amounts of each of the reagents may be suitably selected based on the target analyte, the intended amplification reaction, and the desired speed and degree of amplification. In some embodiments, the reagent composition includes at least 0.2 units, at least 0.3 units, at least 0.5 units, at least 1 unit, at least 2 units, at least 3 units, at least 4 units, or at least 5 units of polymerase. In some embodiments, the reagent composition includes at most 1 unit, at most 2 units, at most 4 units, or at most 6 units of polymerase.

In some embodiments, the reagent composition includes 0.1 mM to 10 mM of nucleotides. In some embodiments, the reagent composition includes 0.5 μM to 10 μM of DNA primers. In some embodiments, the reagent composition includes 1.0 mM to 50 mM of one or more salts. In some embodiments, the reagent composition includes 10 mM to 100 mM of buffer components.

PCR, e.g., LAMP, can be used to amplify a segment of a nucleic acid such as RNA or DNA, and therefore can be used to amplify the signal of an analyte that contains a nucleic acid. This may be particularly useful in samples that otherwise may contain few of the target analytes, such as a sample obtained from exhalation airflow onto a porous sample collection media.

According to an embodiment, the system of the present disclosure does not require elution of the sample from the porous sample collection media prior to amplification. Rather, the amplification may be performed in and on the porous sample collection media, e.g., around and within the porous spaces of the media. The reagent solution (containing the reagent composition and the liquid) is applied directly onto the loaded porous sample collection media. The porous sample collection media and reagent solution are heated to a predetermined reaction temperature for a predetermined duration of time in the heatable reaction zone. In some embodiments, if the target analyte is present, the reagent composition may cause a detectable color reaction. In some embodiments, the color reaction is detectable by the naked eye. In some embodiments, the color reaction may be measured using a colorimeter. The amplified sample may further be applied onto an assay for detection of the target analyte.

The degree of amplification that can be achieved by the amplification system may depend on a number of variables. For example, the degree of amplification may depend on the amount of reagents used, the types of reagents used, and the incubation time. In some embodiments, the sample may be amplified 10× or more; 50× or more; 100× or more; 500× or more; 1,000× or more; 5,000× or more; 10,000× or more; 50,000× or more; 100,000× or more; 500,000× or more; 1,000,000× or more; 5,000,000× or more; 10,000,000 (10⁷)× or more; 50,000,000× or more, 10⁸× or more, 10⁹× or more, or 10¹⁰× or more. Although there is no desired upper limit, in practice, the sample may be amplified up to 10³⁰×.

The limit of detection that can be achieved by the systems described herein may depend on many factors, such as the quality and source of the sample tested, the amplification reaction components used, the reaction time, and the reaction temperature. The limit of detection may be expressed as the lowest number of copies of a target nucleic acid present in a sample that can be detected. In some embodiments, the systems described herein can detect as few as 1 copy, as few as 2 copies, as few as 10 copies, as few as 20 copies, as few as 50 copies, as few as 100 copies, as few as 200 copies, as few as 300 copies, as few as 400 copies, as few as 500 copies, as few as 600 copies, as few as 700 copies, as few as 800 copies, as few as 900 copies, as few as 1,000 copies, as few as 1,100 copies, as few as 1,200 copies, as few as 1,500 copies, or as few as 2,000 copies of a target nucleic acid.

The incubation time of the amplification reaction (e.g., PCR, e.g., RT-PCR, e.g., LAMP) may be selected to balance a desirably fast test time and maximum amplification. The incubation time may be 5 min or longer, 10 min or longer, 15 min or longer, 20 min or longer, 25 min or longer, or 30 min or longer. The incubation time may be 120 min or shorter, 90 min or shorter, 60 min or shorter, 50 min or shorter, 45 min or shorter, 40 min or shorter, 35 min or shorter, or 30 min or shorter. In some embodiments, the incubation time is in a range of 10 min to 90 min or 15 min to 45 min.

The incubation temperature (predetermined reaction temperature) may be selected based on the reagents used in the reagent composition. For example, the incubation temperature may be selected as the optimal temperature for the polymerase enzyme used in the reagent composition. The incubation temperature of PCR commonly cycles between two or three temperatures in the range of 30° C. to 98° C. PCR may include temperature cycles, where a high temperature (e.g., about 98° C.) is used to denature the sample, a lower temperature (e.g., about 45° C. to 60° C.) is used for annealing, and a medium temperature (e.g., about 70° C. to 75° C.) is used for extension. Amplification reactions, such as PCR, may include an initial denaturation, during which the sample is held at the high temperature to fully dissociate any secondary structure or proteins on the target nucleic acid. Amplification reactions may additionally include a final extension, during which the sample is held at the medium temperature to allow the polymerase to finish filling in any partially-extended sequences. LAMP reactions commonly use a single temperature that may be in the range of 37° C. to 75° C. In some embodiments, the reagent composition includes LAMP reagents and the predetermined reaction temperature is 35° C. or greater, 37° C. or greater, 40° C. or greater, 45° C. or greater, 50° C. or greater, 55° C. or greater, 60° C. or greater, 62° C. or greater, or 65° C. or greater. The predetermined reaction temperature may be 75° C. or less, 70° C. or less, 68° C. or less, or 65° C. or less. The predetermined reaction temperature may be from 50° C. to 75° C., 55° C. to 70° C., 58° C. to 65° C., or about 60° C.

In some embodiments, there are two or more predetermined temperatures, where a first temperature is maintained for a first duration of time and a second temperature is maintained for a second duration of time.

The various parts of the reagent composition may be provided as a mixture or may be kept separate (e.g., in two or more parts) until the amplification of the sample is performed. For example, to maintain the integrity of the reagents, it may be desirable to not mix the DNA primers with some of the other ingredients in a liquid media until shortly before use. In some embodiments, the reagent composition is provided in two parts, where a first part includes the buffer, polymerase enzyme, nucleotides, and salts, and a second part includes the DNA primers. For example, the first part may include tris(hydroxymethyl)aminomethane, Bst DNA polymerase, dNTPs, and optionally one or more of magnesium chloride, magnesium sulfate, potassium chloride, ammonium sulfate, and a dye. This may be particularly suitable in embodiments where one or more reagents are provided in solution. One or both of the first and second parts may be in the form of a liquid. Each of the liquid parts may be contained in the liquid reservoir. In some embodiments, the reagent composition includes a first liquid reagent contained in a first compartment of the liquid reservoir and a second liquid reagent contained in a second compartment of the liquid reservoir.

Alternatively, one or more parts of the reagent composition may be provided as a dry mixture that is reconstituted with a liquid shortly before use. The liquid mixture and the liquid may be mixed to form a liquid reagent. The dry mixture may be, for example, a lyophilized powder or matrix. The liquid may be an aqueous liquid, such as water or an aqueous buffer. The dry mixture may include one or more of the polymerase enzyme, nucleotides, and DNA primers. In some embodiments, the dry mixture includes at least the DNA primers. In some embodiments, the dry mixture includes the polymerase enzyme, the nucleotides, and the DNA primers. The dry mixture may further include one or more salts and buffer components. The dry mixture may further one or more of the additional components. In embodiments where the reagent composition includes a dry lyophilized mixture, the mixture may include excipients commonly used with lyophilization. For example, the dry lyophilized mixture may include one or more of a sugar, polyol, polymer, surfactant, chelating complex, or a combination thereof. Some of the components may be provided in the liquid used to reconstitute the dry mixture. The liquid may be contained in the liquid reservoir. The dry mixture may be contained in a reservoir that is separate from the liquid reservoir. According to an embodiment, the reagent composition includes reagents that amplify the sample. Amplification of the sample enables detection of a target analyte at a lower concentration that without amplification. For example, the presence of a virus or other pathogen may be detected at a lower viral load or pathogen load than without amplification. This may enable earlier detection of an infection, or detection at a load that may not yet cause symptoms but may nevertheless be contagious. It may also enable earlier treatment and/or quarantining if an infection is detected.

The amplification system includes a heatable reaction zone and a heating system arranged to heat the heatable reaction zone to a desired, predetermined reaction temperature for the duration of the incubation time. The predetermined reaction temperature may be selected based on the particular PCR reaction utilized to amplify the sample. Generally, the predetermined reaction temperature may be in the range of 30° C. to 98° C. The heatable reaction zone may be an area or portion of the housing that is constructed to receive the porous sample collection media and at least a portion of the liquid and the reagent composition. The liquid and the reagent composition may be mixed prior to applying onto the porous sample collection media, or concurrently while being applied onto the porous sample collection media. Any suitable heating system capable of heating the porous sample collection media, the liquid, and the reagent composition in the heatable reaction zone to the predetermined reaction temperature for the desired duration may be used. Examples of suitable heating systems include an external heating block or a heater that is internal to the housing, where the heater includes a resistive heating element, an inductive heating element, or a controlled chemical reaction. The heater may be connected or connectable to a source of energy and/or a control unit. The source of energy may be, for example, a battery or connection to a power outlet. The housing may include elements to facilitate communication with the control unit, such as a thermocouple or thermostat. The control unit may be a control unit specifically designed for the purpose or may be a smart phone or personal computer that is configured to control the heater (e.g., the temperature and duration of heating) via an app. The control unit may also alert the user to when the amplification reaction is complete. The heating system may include a mechanism for reducing the heat generated by a heating element or a mechanism for cooling the heating element. The heating system may include heat dispersion layers to spread the heat more uniformly throughout the heatable reaction zone. The heating system may further include insulating elements or layers to maintain heat in the intended area.

An example of an external heating block that may be used with the sample collection and analysis system is the 3M™ ATTEST™ Mini Auto-Reader, available from 3M Company in St Paul, MN. The external heating block may include various controls, such as temperature control and timer. The external heating block may further include colorimeter capability, and may be automated to indicate assay result.

According to an embodiment, the porous sample collection media is suitable for exhalation through the media. That is, the porous sample collection media has sufficient porosity to allow exhalation through the media. As used here, the term “porosity” refers to a ratio of open space in the media to the amount of volume taken by the media material itself. A media with high porosity has more open space and, therefore, allows higher flow with a lower pressure drop.

According to an embodiment, the porous sample collection media is a nonwoven material carrying an electrostatic charge. The electrostatic charge may enable capturing pathogens, viruses, or other analytes from an exhalation airflow. In some cases, the porous sample collection media may be a hydrophobic nonwoven material. In other cases, the porous sample collection media may be a hydrophilic nonwoven material. The porous sample collection media may be a hydrophobic nonwoven material carrying an electrostatic charge configured to capture pathogens, viruses, or other analytes from an exhalation airflow. The porous sample collection media may be a hydrophilic nonwoven material carrying an electrostatic charge configured to capture pathogens, viruses, or other analytes from an exhalation airflow. The term “hydrophobic” refers to a material having a water contact angle of 90 degrees or greater, or from about 90 degrees to about 170 degrees, or from about 100 degrees to about 150 degrees. The term “hydrophilic” refers to a material having a water contact angle of less than 90 degrees. Water contact angle is measured using ASTM D5727-1997 Standard test method for surface wettability and absorbency of sheeted material using an automated contact angle tester.

The porous sample collection media may be formed of any suitable material that is capable of capturing viruses, pathogens, or other analytes from exhalation airflow and releasing the captured viruses, pathogens, or other analytes upon being contacted with an eluent, such as a saline solution. The porous sample collection media may be formed of polymeric material. The porous sample collection media may be formed of a polyolefin. Examples of suitable polyolefins include polypropylene, polylactic acid, and the like, and a combination thereof. In one embodiment the porous sample collection media is formed of polypropylene. In one embodiment the porous sample collection media is formed of polylactic acid. One illustrative porous sample collection media is commercially available from 3M Company (St. Paul MN, U.S.A.) under the trade designation FILTRETE Smart MPR 1900 Premium Allergen, Bacteria & Virus Air Filter Merv 13.

The porous sample collection media may have a thickness (orthogonal to the major plane) of 200 μm or greater or 250 μm or greater. The porous sample collection media may have a thickness of 750 μm or less or 1000 μm or less. The porous sample collection media may have a thickness of in a range from 200 μm to 1000 μm, or from 250 μm to 750 μm. The porous sample collection media may have major plane surface area (of one side) of 1 cm² or greater or 2 cm² or greater. The porous sample collection media may have major plane surface area of 3 cm² or less or 4 cm² or less. The porous sample collection media may have major plane surface area in a range from 1 cm² to 4 cm², or 2 cm² to 3 cm².

The porous sample collection media may be housed in the housing together with the amplification system. In some embodiments, the porous sample collection media is disposed in the heatable reaction zone. Alternatively, the porous sample collection media is initially disposed within a separate sample collection device and may be transferred to the heatable reaction zone after having been loaded with a sample. Various devices and housing options are further discussed below with regard to the drawings.

The amplification system includes a liquid reservoir, a liquid contained within the liquid reservoir, and a reagent composition. In some embodiments, the reagent composition is contained within the liquid reservoir and may be dissolved in the liquid. The reagent composition may be provided in two or more parts, each part being contained in a separate compartment of the liquid reservoir. In some embodiments, the reagent composition is a dry mixture and is reconstituted with the liquid from the liquid reservoir upon use. The liquid, whether contained in a single compartment or split into separate compartments, and whether provided separately from the reagent composition or as a part of it, may form a metered dose of liquid.

The liquid may be an aqueous liquid. The liquid may be a buffer solution. The liquid may be an aqueous buffer solution. The liquid may be a saline solution. The liquid may include a surfactant. A “surfactant” is generally understood to mean a molecule that can be added to a solution to reduce the surface tension of the solution. The liquid may be formulated to have a surface tension that facilitates its release from the reservoir and wetting of the porous sample collection media. For example, the surface tension of the liquid may be lower than that of water.

The liquid may have a contact angle of greater than 90 degrees when measured on the porous sample collection media. The liquid may be a saline solution including a surfactant. The liquid (e.g., a buffer or a saline solution) may include from 0.1 wt-% or more or 0.5 wt-% or more, and up to 1 wt-% or up to 2 wt-% of surfactant. The metered dose of liquid may have a volume of 50 μL or greater, 100 μL or greater, 150 μL or greater, 200 μL or greater, or 250 μL or greater. The metered dose of liquid may have a volume of 1200 μL or less, 1000 μL or less, 750 μL or less, 500 μL or less, or 400 μL or less. The metered dose of liquid may have a volume of 50 μL to 1000 μL or 100 μL to 500 μL.

The liquid reservoir containing the metered dose of liquid may be disposed within the housing. The liquid reservoir may be formed by the housing itself or may be provided as a liquid capsule disposed within the housing. Alternatively, the liquid reservoir may be separate from the housing. The liquid reservoir may be constructed to release a metered dose of liquid onto the porous sample collection media. The liquid reservoir may be constructed to facilitate mixing of two liquids or the liquid and a reagent composition provided as a dry mixture.

The liquid reservoir may have one, two, three, or more compartments. The number of compartments may be selected based on the type of reagent composition. For example, a reagent composition that includes two liquids may be facilitated by a liquid reservoir having two compartments. A reagent composition that includes a dry powder may be facilitated by a liquid reservoir having a single compartment. Regardless of the number of compartments, the liquid reservoir may be constructed to release the liquid (or multiple liquids) onto the porous sample collection media. The liquid reservoir may include a release mechanism. The release mechanism may seal the liquid reservoir until it is activated by a user. The release mechanism may be positioned between the liquid reservoir and the porous sample collection media. Activating the release mechanism may be arranged to put the interior volume of the liquid reservoir in fluid communication with the porous sample collection media. Any suitable release mechanism may be used. For example, the release mechanism may include a breakable membrane or a removable portion. The breakable membrane may be arranged to be rupturable, puncturable, tearable, etc. The removable portion may be, for example, a pull tab. Liquid reservoirs that include two or more compartments may include two or more release mechanism, respectively, that may be activated independently. The liquids from the two or more compartments may be released simultaneously or in succession.

The liquid reservoir may be a separate element from the amplification system. The liquid reservoir may be configured to be received by the housing. The housing may include a receptacle (e.g., reservoir) for receiving the liquid reservoir. The liquid reservoir may be provided as a capsule. One illustrative metered fluid dose element is commercially available from 3M Company (St. Paul MN, U.S.A.) under the trade designation CUROS. Alternatively, the liquid reservoir may be a dropper or other container that may be used to transfer the liquid onto the porous sample collection media.

The liquid reservoir may be deformable and configured to discharges fluid from the liquid reservoir upon a user squeezing the deformable surface of the liquid reservoir.

The liquid reservoir may be prepared from any suitable material, such as polyethylene (PE), polypropylene (PP), polyester terephthalate (PET), or the like. The liquid reservoir may be constructed to receive a liquid capsule containing the liquid.

In some embodiments, the liquid reservoir is removably sealed by a removable tab. The removable tab may be sealed onto the opening of the liquid reservoir by a peelable seal. A user may peel the tab off of the liquid reservoir opening to release the liquid onto the porous sample collection media.

According to an embodiment, the sample collection and analysis system includes a sample collection device. The sample collection device housing defines an airflow path extending from an air inlet to an air outlet. The air inlet is configured to receive an exhalation airflow. A porous sample collection media is disposed within the housing and along the airflow path. Exhalation airflow may be flown (e.g., blown) through the airflow path to load the porous sample collection media with a sample.

The sample collection device housing may include a mouthpiece or nosepiece or another structure that facilitates breathing into the air inlet. For convenience, reference is made here to a mouthpiece but it should be understood that the structure may also be a nosepiece or other suitable structure. The mouthpiece may be aligned with the inlet opening. The mouthpiece may help a user direct exhalation airflow onto the porous sample collection media. The mouthpiece may be integral with the housing or may be removably coupled with the housing.

In some embodiments, the sample may be collected from an aerosol, a solid surface, a liquid, or other non-breath sample. For example, the sample may be collected from a bodily fluid or a surface of the body. The sample may be collected from a solid surface, such as the surface of furniture, a building, or the like. The sample may be collected from a filtration system, such as an air filter, a water filter, a mask or respirator, or the like. The sample may be collected by using a swab, a wipe, filtration media, or the like. In some embodiments, the sample is collected by swiping using a piece of sample collection media. Samples collected by two or more methods may be combined. For example, a sample collected from exhalation airflow may be combined with a sample collected using a wipe or a swab.

According to an embodiment, the sample collection and analysis system includes an assay configured to analyze the amplified analyte, such as a virus, other pathogen, or other analyte. Any suitable assay may be used. The assay may be constructed to determine the presence or absence of a target virus, pathogen, or analyte in the collected sample. In some embodiments, the assay is a lateral flow assay (“LFA”), a vertical flow assay (“VFA”), or a colorimetric indicator. LFAs and VFAs are generally paper-based platforms for the detection and quantification of analytes in complex mixtures, including biological samples such as saliva, urine, etc. LFAs and VFAs are typically easy to use and can be used both by professionals in a health care setting or laboratory as well as by lay persons at home. Typically, a liquid sample is placed on the assay in a sample receiving region and is wicked by capillary flow along the device to a test region. LFAs and VFAs are typically based on antigens or antibodies that are immobilized in the test region and that selectively react with the analyte of interest. The result is typically displayed within 5 to 30 minutes. LFAs and VFAs can be tailored for the testing of a variety of viruses and other pathogens, as well as many other types of analytes. According to an embodiment, the assay used in the sample collection and analysis system of the present disclosure is constructed for the detection of an amplified target virus, target pathogen, or other target analyte, that has been amplified by the amplification system. According to an embodiment, the assay used in the sample collection and analysis system of the present disclosure is constructed for the detection of a target virus, target pathogen, or other target analyte, that may be present in the exhalation air flow of a subject.

Examples of commercially available LFAs that may be included in the sample collection and analysis system include AccessBio CARESTART™ COVID-19 Antigen Home Test, Abbott BINAXNOW™ COVID-19 Antigen Self Test, and Quidel QUICKVUE® At-Home OTC COVID-19 Test.

Examples of colorimetric indicators include LFA colorimetric readers utilizing image sensors, such as a charge-coupled device (CCD) or complementary metal oxide semiconductor (CMOS). Such devices are useful, at least in part, due to their simple structure and small size. In some embodiments, the device may include one or more LED light indicators integrated with the device. The LED light indicator may indicate the result read directly from the substrate. When the device is used, the LFA develops a test line, which is an aggregate of labeled particles, antigens, and antibodies. An image sensor-based LFA reader acquires an image of the test line analyzes the pixel intensity of the test line, which changes according to the concentration of the target analyte.

The assay may be integral with the amplification system. The assay may form a unitary element with the housing of the amplification system. The assay may be a separate element from the amplification system. The assay may be configured to attach to the amplification system. The amplification system may include a receptacle for receiving at least a portion of the assay. The amplification system may include a receptacle for receiving the entire assay. The assay may be a replacement element with the amplification system.

According to an embodiment, the sample collection device, amplification system, and assay forms a singular self-contained unit. Providing a self-contained unit allows for convenient shipping and transportation of the sample collection and analysis system and for disposal after use. The self-contained unit may have a compact size and may be conveniently carried in a pocket or purse. The self-contained unit may be safely disposed of after use among ordinary waste disposal.

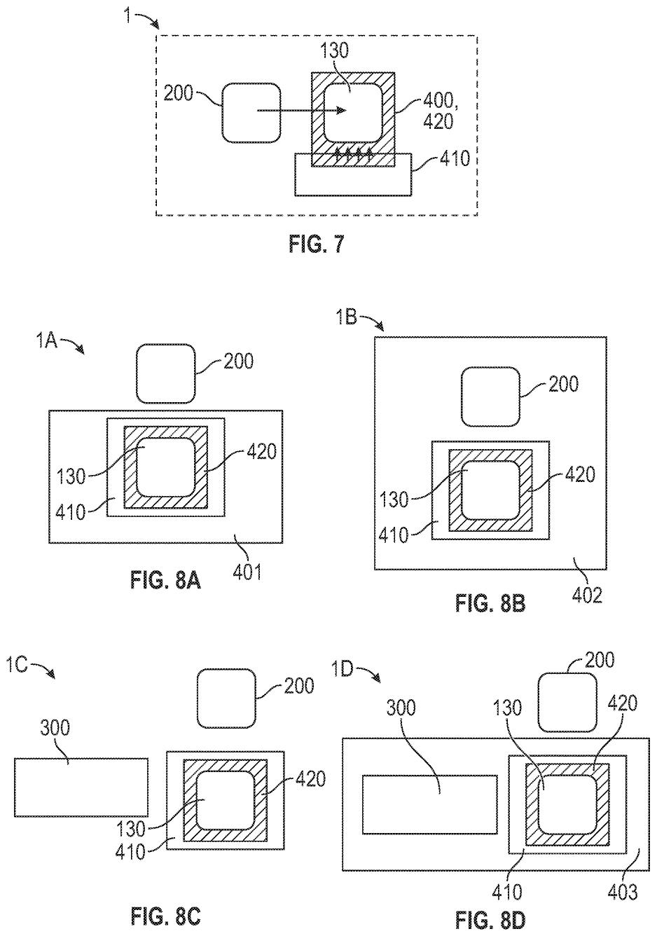

Referring now to FIG. 7, according to an embodiment, the system 1 includes porous sample collection media 130, a liquid reservoir 200, and a heating system 410. The porous sample collection media 130 is configured to capture a sample from exhalation air. The liquid reservoir 200 contains a liquid and one or more reagents. The liquid reservoir 200 may contain a reagent composition. The liquid reservoir 200 may contain two different liquid compositions, for example, in separate compartments. The two different liquid compositions together may form the reagent composition. Alternatively, the liquid reservoir 200 may contain a liquid composition that forms a part of the reagent composition, and another part (liquid or solid) may be contained separately, either in a compartment of the liquid reservoir 200 or in a separate reservoir. The liquid reservoir 200 is configured to deliver the liquid (or two or more different liquid compositions) onto the porous sample collection media 130. The heating system 410 is configured to heat a heatable reaction zone 420 to a predetermined reaction temperature for the duration of the incubation time. The liquid reservoir 200, the reagent composition, the heatable reaction zone 420, and the heating system 410 collectively form an amplification system. The amplification system is configured to amplify a sample collected in the porous sample collection media 130.

The system 1 is not particularly limited by the shape and form of the housing, or the location of the various components relative to the housing. In its simplest configuration, the system 1 includes a housing 400 that only houses the heatable reaction zone 420 and the porous sample collection media 130, as show in FIG. 7.

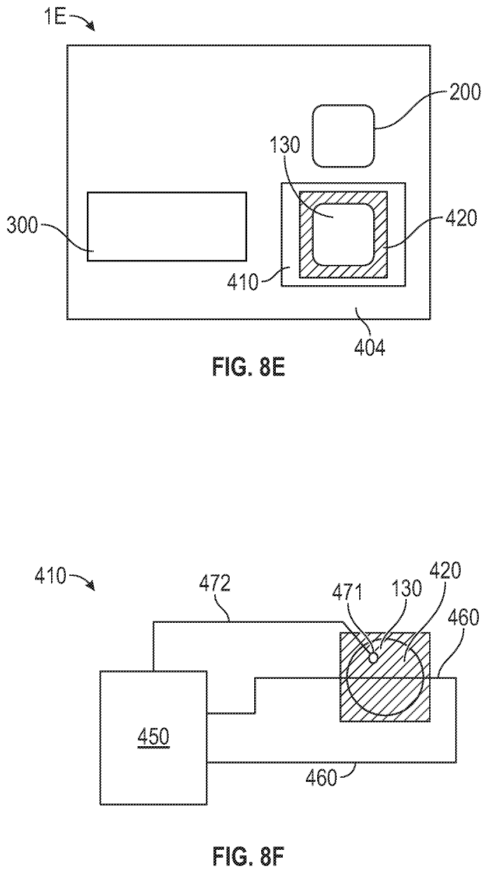

In some embodiments, schematically illustrated in FIG. 8A, the system 1A includes a housing 401 that houses the heating system 410, the heatable reaction zone 420, and the porous sample collection media 130. The liquid reservoir 200 may be provided as a separate item. In some embodiments, schematically illustrated in FIG. 8B, the system 1B includes a housing 402 that houses the heating system 410, the heatable reaction zone 420, the porous sample collection media 130, as well as the liquid reservoir 200.

In some embodiments, schematically illustrated in FIG. 8C, the system 1C includes a heating system 410, a heatable reaction zone 420, a porous sample collection media 130, a liquid reservoir 200, and an assay 300. The assay 300 may be configured to detect the presence of an analyte of interest in a sample captured in the porous sample collection media 130. The assay 300 may be configured to detect a nucleic acid from an analyte of interest. The assay 300 may be configured to detect a nucleic acid amplified by the amplification system.

In some embodiments, schematically illustrated in FIG. 8D, the system 1D includes an assay 300 that is housed within the housing 403 that also houses the heating system 410, the heatable reaction zone 420, and the porous sample collection media 130.

In some embodiments, schematically illustrated in FIG. 8E, the system 1E includes an assay 300 that is housed within the housing 404 that also houses the heating system 410, the heatable reaction zone 420, the porous sample collection media 130, as well as the liquid reservoir 200. In such embodiments, all of the parts of the system 1E may form an integral system, housed in the same housing 404. Alternatively, the housing 404 may house the heating system 410, the heatable reaction zone 420, the assay 300, and the porous sample collection media 130, and the liquid reservoir 200 may be provided as a separate item.

The various types of housing 401, 402, 403, 404 are collectively referred to as housing 400. The housing 400 may take various forms and shapes to accommodate the parts of the system 1 housed within the housing 400. The housing 400 may include additional parts, such as a mouthpiece or nosepiece and an airflow path or channel for receiving an exhalation airflow and for directing the airflow through the porous sample collection media 130. The housing may also include a lid, cap, cover, seal, pull tab, or the like, for removably sealing the liquid reservoir 200. In embodiments where the system 1 includes an assay 300, the housing 400 may include elements that facilitate directing (e.g., flowing) the amplified sample from the porous sample collection media 130 to the assay 300, and a result viewing window for viewing the result of the assay and/or amplification reaction. The housing 400 may also include various insignia, including instructions or directions for a user to capture, amplify, and/or analyze a sample, and/or a machine-readable optical label. The insignia may include information about the device and the assay, such as identity, manufacturer, expiration date, and the like. Exemplary machine-readable optical labels may include, for example, a bar code and a QR (quick response) code. The machine-readable optical label may be configured to display the result of the assay. The machine-readable optical label may be used to read and record the result. An electronic reader capable of reading machine-readable optical labels may be used to read and record the result. An electronic reader may be, for example, a smart phone, a tablet, a laptop, or bar code reader or QR code reader. The electronic reader may further be used to transmit the result, for example, to a healthcare provider or to a database.

A schematic view of the heating system 410 is shown in FIG. 8F. The heating system 410 may be used in any of the sample collection and analysis systems shown. The shape and size of the elements of the heating system 410 may be modified to fit the sample collection and analysis system as desired. In the embodiment shown, the heating system 410 includes a control unit 450.

The control unit 450 may also include a power source, such as a battery or a connection to an external power source, such as an external battery or an electrical outlet. The heating system 410 includes an electrical connection 460 connected to heating element 461 configured to heat the sample collection media 130 to a desired temperature. The heating element 461 may be positioned adjacent the sample collection media 130. The heating element 461 may extend across or through the sample collection media 130. The heating element 461 may act as a resistive heating element to heat the sample collection media 130. Alternatively, the heating element 461 may be part of an inductive heating element and the sample collection media 130 may include a susceptor material heated by the inductive heating element. Both ends of the electrical connection 460 may be connected to the control unit 450, which may be configured to actuate and control heating by modulating power to the wire 460. The heating system 410 may further include a temperature sensor 471 disposed on or adjacent the sample collection media 130 and configured to sense the temperature of the sample collection media 130 or the heatable reaction zone 420. Any suitable heat sensing element may be used as the temperature sensor 471, such as a thermistor, thermocouple, resistance temperature detector (RTD), or the like. The temperature sensor 471 may be connected to the controller 450 via connection 472. The temperature sensor 471 is configured to generate a signal. The controller 450 includes a processor that is configured to receive the signal from the temperature sensor 471, and to determine the temperature of the sample collection media 130 or the heatable reaction zone 420.

In one or more embodiments, the control system may be described as being implemented using one or more computer programs executed on one or more programmable processors that include processing capabilities (for example, microcontrollers or programmable logic devices), data storage (for example, volatile or non-volatile memory or storage elements), input devices, and output devices. Program code, or logic, described herein may be applied to input data to perform functionality described herein and generate desired output information. The output information may be applied as input to one or more other devices or processes as described herein or as would be applied in a known fashion.

The computer program products used to implement the processes described herein may be provided using any programmable language, for example, a high-level procedural or object orientated programming language that is suitable for communicating with a computer system. Any such program products may, for example, be stored on any suitable device, for example, a storage media, readable by a general or special purpose program, controller apparatus for configuring and operating the computer when the suitable device is read for performing the procedures described herein. In other words, at least in one embodiment, the system may be implemented using a non-transitory computer readable storage medium, configured with a computer program, where the storage medium so configured causes the computer to operate in a specific and predefined manner to perform functions described herein.

The exact configuration of the controller 450 of the system is not limiting and essentially any device capable of providing suitable computing capabilities and control capabilities to implement the method may be used. In view of the above, it will be readily apparent that the functionality may be implemented in any manner as would be known to one skilled in the art. As such, the computer language, the controller, or any other software/hardware which is to be used to implement the processes described herein shall not be limiting on the scope of the systems, processes, or programs (for example, the functionality provided by such processes or programs) described herein. The methods and processes described in this disclosure, including those attributed to the systems, or various constituent components, may be implemented, at least in part, in hardware, software, firmware, or any combination thereof. For example, various embodiments of the techniques may be implemented within one or more processors, including one or more microprocessors, DSPs, ASICs, FPGAs, CPLDs, microcontrollers, or any other equivalent integrated or discrete logic circuitry, as well as any combinations of such components. When implemented in software, the functionality ascribed to the systems, devices, and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more embodiments of the functionality.

Various types of sample collection and analysis systems suitable for use with or without modification for the system of the present disclosure are described, for example, in PCT/US2021/034327 filed on 26 May 2021; PCT/US2021/041485 filed on 13 Jul. 2021; PCT/IB2022/059989 filed on 18 Oct. 2021; PCT/US2022/012392 filed on 14 Jan. 2022; PCT/US2022/014388 filed on 28 Jan. 2022; PCT/IB2022/051250 filed on 11 Feb. 2022; PCT/IB2022/051251 filed on 11 Feb. 2022; PCT/IB2022/051252 filed on 11 Feb. 2022; PCT/US2022/019399 filed on 8 Mar. 2022; PCT/IB2022/054633 filed on 18 May 2022; PCT/IB2022/054683 filed on 19 May 2022; PCT/IB2022/054852 filed on 19 May 2022; PCT/IB2022/056708 filed on 20 Jul. 2022; PCT/IB2022/056714 filed on 20 Jul. 2022; each of which is incorporated herein by reference.

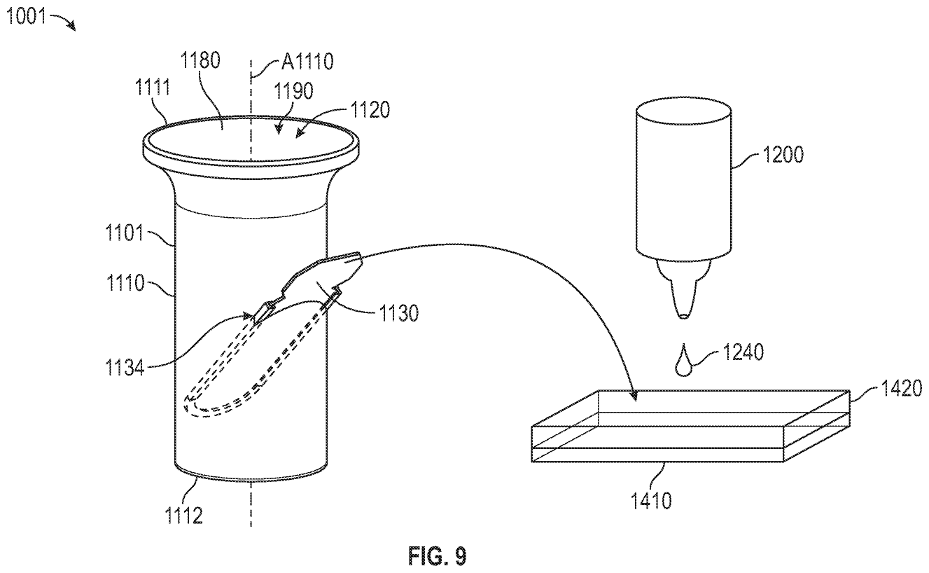

In some embodiments, illustrated in FIG. 9, the system 1001 includes a sample collection device 1101 having a tubular body 1110 with a longitudinal center axis A1110 and defining an airflow path 1120 extending through the sample collection device 1101. The airflow path 1120 may extend from a first end 1111 of the device 1101 to a second end 1112. The sample collection device 1101 is constructed to position the sample collection media 1130 to occlude the airflow path 1120. The first end 1111 of the sample collection device 1101 may form a mouthpiece 1180 with an opening 1190 into the airflow path 1120. In the embodiment shown, the airflow path 1120 extends along the longitudinal center axis A1110 of the tubular body 1110. The tubular body 1110 has an opening 1139 for insertion of the sample collection media 1130. The opening 1139 may be a slot in the wall of the tubular body 1110. A user may capture a sample on the porous sample collection media 1130 to form a loaded sample collection media by exhaling through the airflow path 1120 of the sample collection device 1101. After capturing the sample, the loaded sample collection media 1130 may be transferred onto a heatable reaction zone 1420. The reagent composition 1240 may be applied onto the loaded sample collection media 1130 from a liquid reservoir 1200. The heating system 1410 may then be used to heat the loaded sample collection media 1130 and the applied reagent composition 1240 to initiate the amplification reaction. The heating system 1410 may include, for example, the heating system 410 of FIG. 8F.

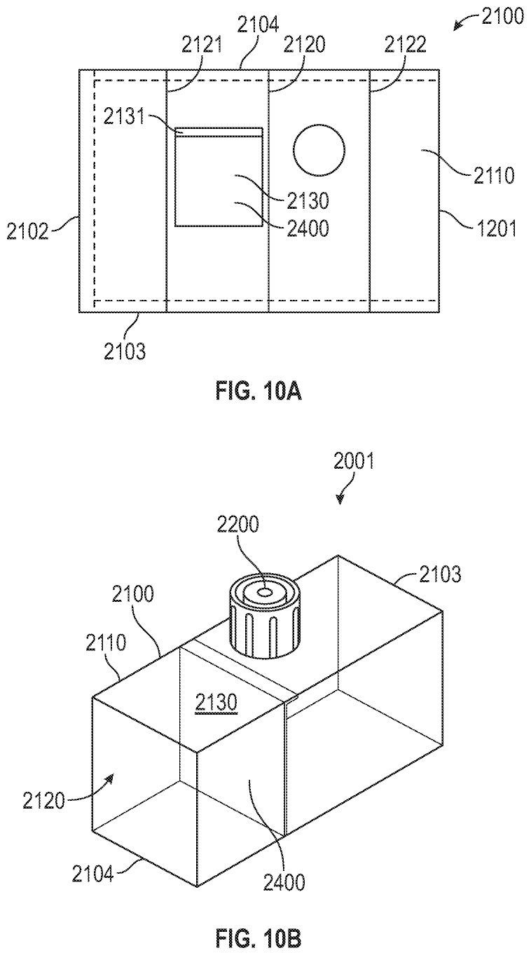

In some embodiments, illustrated in FIGS. 10A-10B, the system 2001 includes a liquid reservoir 2200 and a sample collection device 2100 with a pop-up housing 2110 that can be folded flat for storage, transport, and disposal, and may be configured into its three-dimensional shape for use. FIG. 10A shows the housing 2110 in its flat configuration. The housing 2110 includes a planar sheet of material 2111 has opposing edges 2101, 2102 separated by second opposing edges 2103, 2104. The planar sheet of material 2111 has at least two (e.g., three) fold lines 2220, 2221, 2222. A porous sample collection media 2130 is fixed to the first major surface of the planar sheet of material 2111 by at least one edge 2131 of the porous sample collection media 2130. By fixing opposing edges 2101, 2102 together, the planar sheet of material 2111 may be formed into a tubular structure forming an airflow channel 2120. The airflow channel 2120 extends from a first end 2115 (e.g., a mouthpiece end) of the housing 2110 to a second end 2116 (e.g., an air outlet end). The porous sample collection media 2130 substantially occludes the airflow channel 2120 between the first end 2115 and the second end 2116. The housing 2110 may further include a heating system 2400 incorporated into the planar sheet of material 2111 and/or the porous sample collection media 2130. The heating system 2400 may include a resistive heating element 2401 or an inductive heating element. The heating system 2400 may include, for example, the heating system 410 of FIG. 8F. Exhalation airflow may flow from the first end 2115 through the porous sample collection media 2130 and exits through the second end 2116 to capture a sample and form loaded sample collection media. The reagent composition may be applied onto the loaded sample collection media 2130 from the liquid reservoir 2200. The heating system 2400 may then be used to heat the loaded sample collection media 2130 and the applied reagent composition to initiate the amplification reaction.

The liquid reservoir 2200 may include a reservoir with seal that is ruptured as the liquid reservoir 2200 is applied onto a corresponding receptacle 2112 on the housing 2110. The receptacle 2112 may include a protrusion that ruptures the seal on the liquid reservoir 2200 and an opening that allows the reagent composition to enter the housing 2110. The receptacle 2112 and the porous sample collection media 2130 may be positioned such that liquid released from the liquid reservoir 2200 flows onto the porous sample collection media 2130. One illustrative liquid reservoir 2200 is commercially available from 3M Company (St. Paul MN, U.S.A.) under the trade designation CUROS. In such embodiments, the receptacle 2112 (e.g., a protrusion) may include a threaded wall that causes a plunger within the liquid reservoir 2200 displace and release the liquid.

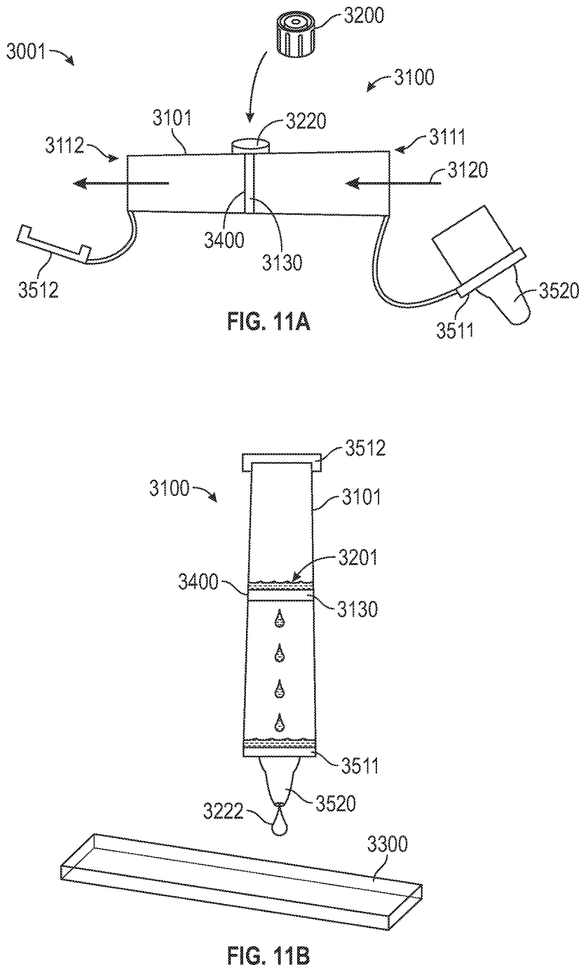

In some embodiments, illustrated in FIGS. 11A-11B, the system 3001 includes a sample collection device 3100 and a liquid reservoir 3200. The system 3001 may further include an assay 3300. The sample collection device 3100 may have a tubular wall 3101 extending from a first end 3111 (e.g., the mouthpiece end) to a second end 3112 (e.g., an air outlet end), defining an airflow channel 3120 from the first end 3111 to the second end 3112. The first end 3111 is configured to receive an exhalation airflow. A porous sample collection media 3130 is fixed within the sample collection device 3100 along the airflow channel 3120. The sample collection device 3100 may further include a heating system 3400 configured to heat a heatable reaction zone containing the porous sample collection media 3130. The heating system 3400 may include a resistive heating element or an inductive heating element. The heating system 3400 may include, for example, the heating system 410 of FIG. 8F.

A first end cap 3511 may be replaceably coupled to the first end 3111. A second end cap 3512 (e.g., an air outlet end cap) may be replaceably coupled to the second end 3112. The first end cap 3511 may include a dropper tip 3520.

The sample collection device 3100 may include a receptacle 3220 configured to receive the liquid reservoir 3200. The receptacle 3220 and liquid reservoir 3200 may be similar to those in the embodiment shown in FIGS. 10A-10B.

A user may collect a sample by exhaling into the first end 3111 of the sample collection device 3100 to produce loaded sample collection media. The user may close the first end cap 3511 and the second end cap 3512. The liquid 3201 containing the reagent composition may then be applied onto the loaded sample collection media 3130 from the liquid reservoir 3200. The heating system 3400 may be activated to heat the loaded sample collection media 3130 and the applied reagent composition to initiate the amplification reaction. The amplified sample 3222 may further be eluted or flown onto an assay 3300 for analysis via an opening in the dropper tip 3520.

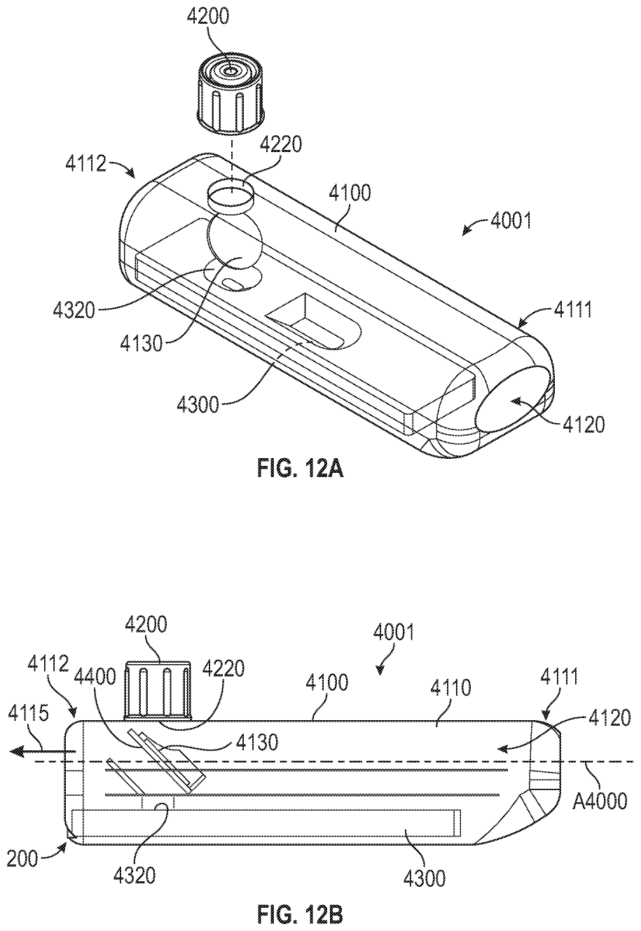

In some embodiments, illustrated in FIGS. 12A-12B, the system 4001 includes a sample collection device 4100 and a liquid reservoir 4200. The sample collection device 4100 has a housing 4110. The housing 4110 of the sample collection device 4100 in these figures is transparent for illustrative proposes only. The housing 4110 extends from a first end 4111 (e.g., the mouthpiece end) to a second end 4112 (e.g., an air outlet end), defining an airflow channel 4120 from the first end 4111 to the second end 4112. The airflow channel 4120 may extend longitudinally along or parallel to a longitudinal axis A4000 of the housing 4110. The first end 4111 is configured to receive an exhalation airflow. The second end 4112 may include an air outlet 4115. A porous sample collection media 4130 is fixed within the sample collection device 4100 along the airflow channel 4120. The system 4001 further includes an assay 4300 for receiving the amplified sample to analyze the analyte of interest. The assay 4300 is housed within the housing 4110. The assay 4300 is positioned to receive a sample from the porous sample collection media 4130. The assay 4300 may include a sample receiving well 4320.

The sample collection device 4100 may further include a heating system 4400 configured to heat a heatable reaction zone containing the porous sample collection media 4130. The heating system 4400 may include a resistive heating element or an inductive heating element. The heating system 4400 may include, for example, the heating system 410 of FIG. 8F.

A user may collect a sample by exhaling into the first end 4111 of the sample collection device 4100 to produce loaded sample collection media. The reagent composition may then be applied onto the loaded sample collection media from the liquid reservoir 4200. The heating system 4400 may be activated to heat the loaded sample collection media and the applied reagent composition to initiate the amplification reaction. The amplified sample may further be eluted or flown onto an assay 4300 for analysis

The porous sample collection media 4130 may be fixed within the housing 4110 and along the airflow channel 4120. The porous sample collection media 4130 at least partially occludes the airflow channel 4120. A user exhales into an opening at the first end 4111 (e.g., the mouthpiece end). The exhalation airflow flows along the airflow channel 4120, coming into contact with the porous sample collection media 4130. The exhalation airflow leaves the sample collection device 4100 through the one or more outlets 4115 at the second end 4112.

The porous sample collection media 4130 is illustrated as having a major plane that forms an angle with the direction of the incident exhalation airflow passing through the airflow channel 4120. This angle may be in a range from about 91 degrees to about 179 degrees, or from about 100 degrees to about 160 degrees, or about 115 degrees to about 150 degrees, or about 125 to about 145 degrees.

The sample collection device 4100 may include a receptacle 4220 configured to receive the liquid reservoir 4200. The receptacle 4220 and liquid reservoir 4200 may be similar to those in the embodiment shown in FIGS. 10A-10B. The liquid reservoir 4200 is configured to couple with the receptacle 4220 and to dispense a metered volume of fluid onto the porous sample collection media 4130. The receptacle 4220 defines an aperture through the housing 4110 and is adjacent to the porous sample collection media 4130. The receptacle 4220 is configured to direct fluid onto the porous sample collection media 4130. The liquid reservoir 4200 may be attached to the receptacle 4220 and movable between a first fluid-loaded position and a second fluid-depleted position, where the second fluid-depleted position may be closer to the housing than the first fluid-loaded position. In the first fluid-loaded position the liquid reservoir 4200 contains the metered volume of liquid and in the second fluid-depleted position the metered liquid reservoir 4200 delivers the metered volume of liquid onto the porous sample collection media 4130. FIG. 12B illustrates the liquid reservoir 4200 in the second fluid-depleted position.

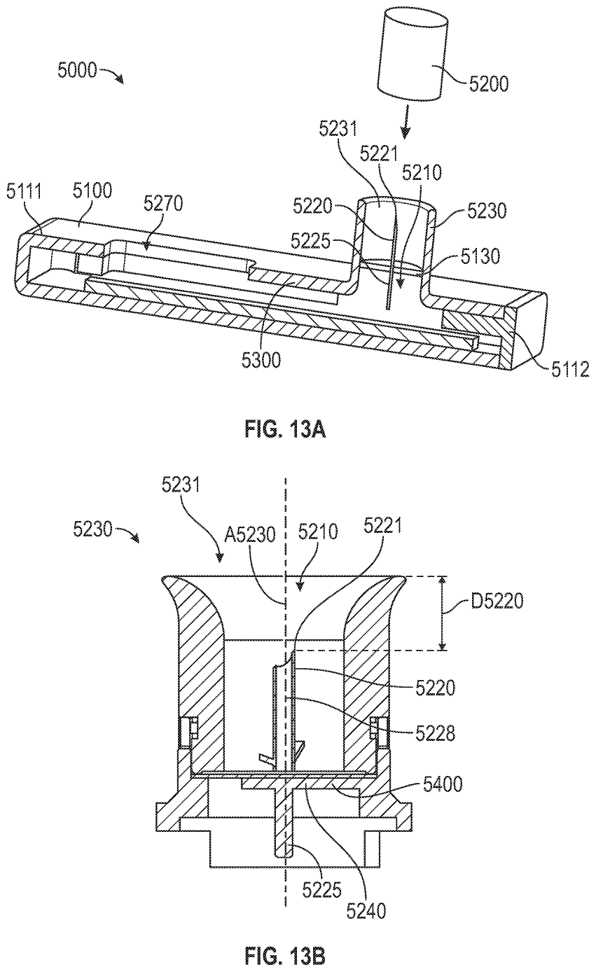

In some embodiments, illustrated in FIGS. 13A-13B, the system 5001 includes a sample collection device 5100 and a liquid reservoir 5200. The sample collection device 5100 has a housing 5110 which may be formed of a first part 5111 and a second part 5112. The housing 5110 includes a mouthpiece 5230, which may be a separate piece coupled with the housing 5110 or may be integrally formed with the housing 5110. The mouthpiece 5230 may define an air inlet 5231 and an airflow path 5210. The air inlet 5231 is configured to receive an exhalation airflow. A porous sample collection media 5130 is fixed within the mouthpiece 5230 along the airflow channel 5120. The porous sample collection media 5130 at least partially occludes the airflow channel 5120. The mouthpiece 5230 includes a piercing element 5220 element extending proximally (toward the air inlet 5231) from a support element 5240 or support grid. The piercing element 5220 may be recessed in the mouthpiece 5230 by a distance D5220 to reduce or minimize the likelihood of a user inadvertently coming into contact with the piercing tip 5221 of the piercing element 5220. The piercing element 5220 may extend along a longitudinal axis A5230 of the mouthpiece 5230. The piercing element 5220 is constructed to pierce, puncture, score, cut, slit, or otherwise rupture a wall or membrane on the liquid reservoir 5200. The piercing element 5220 may further be constructed to act as a fluid guide. The piercing element 5220 may be constructed to draw fluid from the liquid reservoir 5200. The piercing element 5220 may be constructed to guide the flow of liquid onto the porous sample collection media 5130. A detailed view of an exemplary mouthpiece element 5230 and piercing element 5220 decoupled from the device 5100 is shown in FIG. 13B.

The piercing element 5220 has a hollow center 5228 that may help guide fluid down toward the porous sample collection element 5130. The piercing element 5220 may include an extension 5225 that extends below the porous sample collection element 5130 and helps guide fluid further down toward the assay 5300.

The sample collection device 5100 may further include a heating system 5400 configured to heat a heatable reaction zone containing the porous sample collection media 5130. The heating system 5400 may include a resistive heating element or an inductive heating element. The heating system 5400 may be incorporated into the support element 5240. The heating system 5400 may include, for example, the heating system 410 of FIG. 8F.

The system 5001 further includes an assay 5300 for receiving the amplified sample to analyze the analyte of interest. The assay 5300 is housed within the housing 5110. The assay 5300 is positioned to receive a sample from the porous sample collection media 5130. The housing 5110 may include a viewing window 5270 that allows a user to view the result of the assay 5300.

A user may collect a sample by exhaling into the mouthpiece 5230 of the sample collection device 5100 to produce loaded sample collection media. The reagent composition may then be applied onto the loaded sample collection media from the liquid reservoir 5200. The heating system 5400 may be activated to heat the loaded sample collection media and the applied reagent composition to initiate the amplification reaction. The amplified sample may further be eluted or flown onto the assay 5300 for analysis

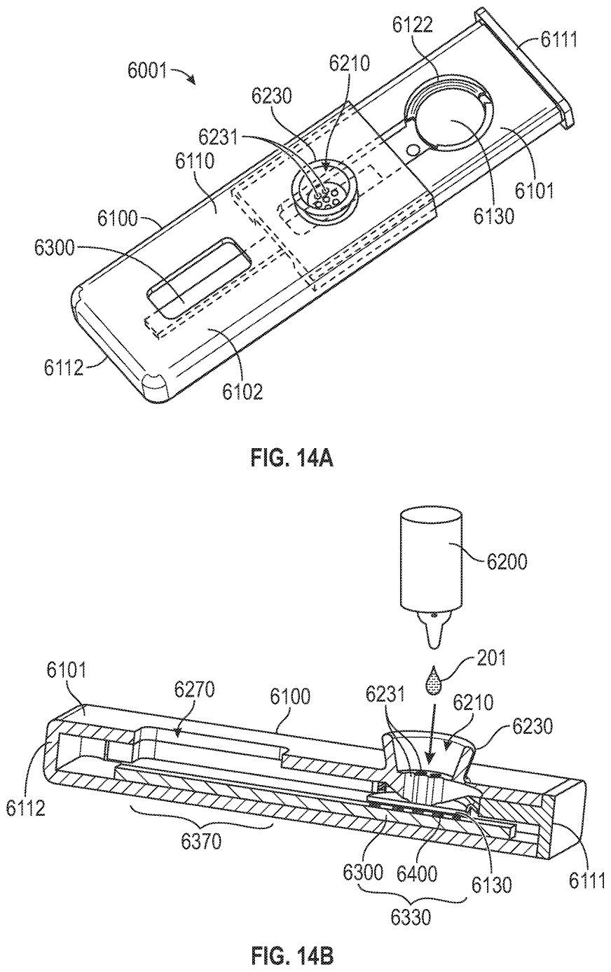

In some embodiments, illustrated in FIGS. 14A-14B, the system 6001 includes a sample collection device 6100 and a liquid reservoir 6200. The sample collection device 6100 has a housing 6110 extending from a first end 6111 to a second end 6112. The housing 6110 may be formed of two parts, 6101 and 6102, where the first part 6101 is received inside the second part 6102. The housing 6110 includes a mouthpiece 6230. The mouthpiece 6230 may be integrally formed on the second part 6102. The mouthpiece 6230 may define an air inlet 6231 (or a plurality of air inlets 6231, as shown) of an airflow path 6210. The air inlet 6231 is configured to receive an exhalation airflow. A porous sample collection media 6130 is fixed within the first part 6101 of the housing. The first part 6101 may include a support element 6122 (e.g., ring) that receives the porous sample collection media 6130 and aligns it with the mouthpiece 6230 along the airflow path 6210 when the first part 6101 is fully inserted inside the second part 6102. The porous sample collection media 6130 at least partially occludes the airflow path 6120.

The sample collection device 6100 may further include a heating system 6400 configured to heat a heatable reaction zone containing the porous sample collection media 6130. The heating system 6400 may include a resistive heating element or an inductive heating element. The heating system 6400 may include, for example, the heating system 410 of FIG. 8F.

The system 6001 further includes an assay 6300 for receiving the amplified sample to analyze the analyte of interest. The assay 6300 is housed within the housing 6110. The assay 6300 may be disposed in the second part 6102 of the housing 6110. The assay 6300 includes a sample receiving area 6330 positioned to receive an amplified sample from the porous sample collection media 6130. The amplified sample may be wicked along the length of the assay 6300 to a test area 6360. Test result appears at a result display area 6370. The result may be viewed through a viewing window 6270 of the housing 6110.

A user may collect a sample by exhaling into the mouthpiece 6230 of the sample collection device 6100 to produce loaded sample collection media. The reagent composition 201 may then be applied onto the loaded sample collection media from the liquid reservoir 6200. The heating system 6400 may be activated to heat the loaded sample collection media and the applied reagent composition to initiate the amplification reaction. The amplified sample may further be eluted or flown onto the assay 6300 for analysis.

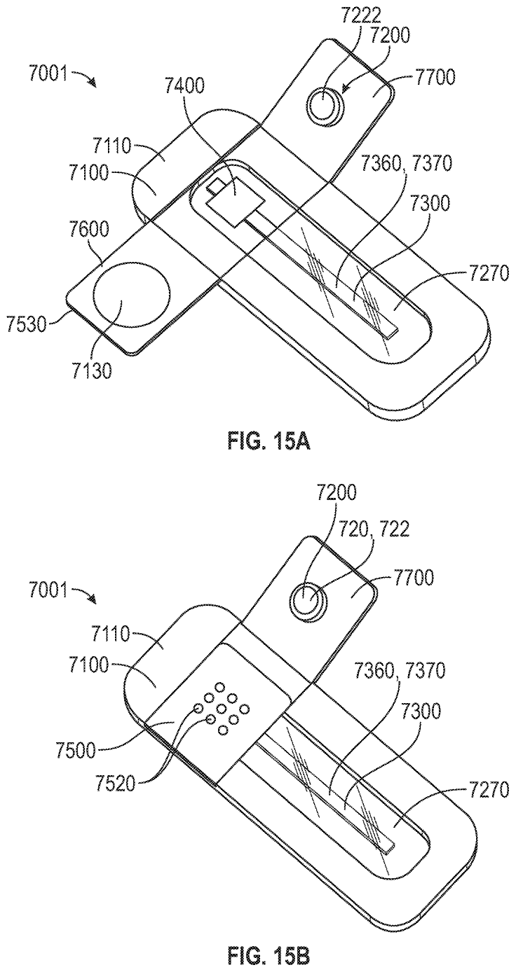

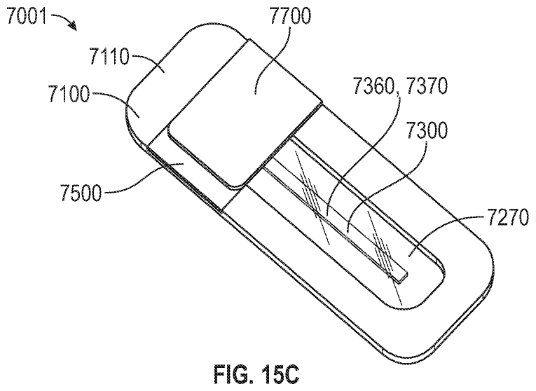

In some embodiments, illustrated in FIGS. 15A-15C, the system 7001 includes a sample collection device 7100 and a liquid reservoir 7200. The sample collection device 7100 has a housing 7110. The sample collection device 7100 may include a first flap 7500 and a second flap 7700, where the first flap 7500 may be folded onto the housing 7110 and the second flap 7700 may be folded onto first flap 7500. A porous sample collection media 7130 may be disposed within the first flap 7500. The first flap 7500 may include air inlet holes 7520 and may serve as a mouthpiece 7530, providing an airflow path extending through the first flap 7500. Alternatively, the housing 7110 may be coupled with a removable mouthpiece that may be coupled with the first flap, aligned with the air inlet holes 7520. The porous sample collection media 7130 is positioned to at least partially occlude the air inlet holes 7520 and thus the airflow path. A liquid reservoir 7200 is housed on the second flap 7700. The liquid reservoir 7200 is positioned such that when the second flap 7700 is folded over the first flap 7500, the liquid reservoir 7200 is aligned with the porous sample collection media 7130. The liquid reservoir 7200 may include a cover or seal 7222 that may be ruptured, pierced, or peeled off to release a metered dose of liquid containing the reagents onto the porous sample collection media 7130.

The sample collection device 7100 may further include a heating system 7400 configured to heat a heatable reaction zone containing the porous sample collection media 7130. The heating system 7400 may include a resistive heating element or an inductive heating element. The heating system 7400 may include, for example, the heating system 410 of FIG. 8F.

The system 7001 further includes an assay 7300 for receiving the amplified sample to analyze the analyte of interest. The assay 7300 is housed within the housing 7110. The assay 7300 is positioned to receive a sample from the porous sample collection media 7130. The housing 7110 may include a viewing window 7270 that allows a user to view the result of the assay 7300.

A user may collect a sample by exhaling through the porous sample collection media 7130 of the sample collection device 7100 to produce loaded sample collection media. The reagent composition may then be applied onto the loaded sample collection media from the liquid reservoir 7200. The heating system 7400 may be activated to heat the loaded sample collection media and the applied reagent composition to initiate the amplification reaction. The amplified sample may further be eluted or flown onto the assay 7300 for analysis.

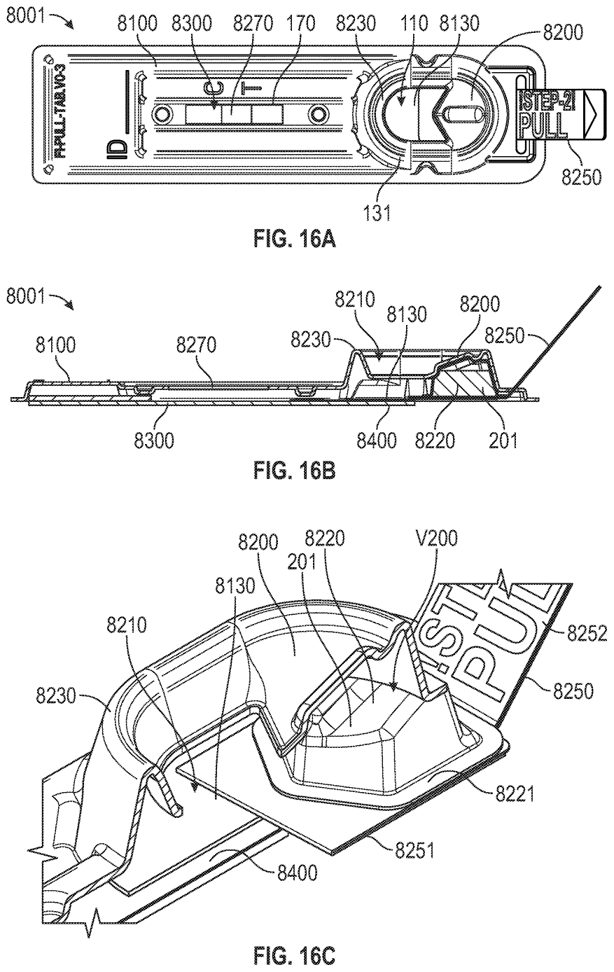

In some embodiments, illustrated in FIGS. 16A-16C, the system 8001 includes a sample collection device 8100 and a liquid reservoir 8200. The sample collection device 8100 has a housing 8110 that includes a mouthpiece 8230 that may be integrally formed with the housing 8110. The mouthpiece 8230 may define has an air inlet 8231 constructed to receive an exhalation airflow. A porous sample collection media 8130 is disposed within the housing. The housing 8110 defines an airflow path 8210 extending from the air inlet 8231 and through the porous sample collection media 8130. The porous sample collection media 8130 at least partially occludes the airflow path 8210.

The housing 8110 further includes a liquid reservoir 8200. According to an embodiment, the liquid reservoir 8200 has a volume V200 housing a metered dose of liquid 201 containing the reagent composition. The liquid reservoir 8200 may be in fluid communication with (e.g., adjacent or immediately adjacent) the porous sample collection media 8130 such that when the liquid 201 is released from the liquid reservoir 8200, it may flow onto the porous sample collection media 8130. The liquid reservoir 8200 defines an opening 8220, which may be removably sealed by a removable tab 8250. The removable tab 8250 is positioned between the opening 8220 and the porous sample collection media 8130.

The liquid reservoir 8200 may include a capsule 8220 disposed within the liquid reservoir 8200, housing the liquid 201. The volume V200 of the liquid reservoir 8200 may be defined by the capsule 8220. The liquid 201 may be dispensed into the capsule 8220 and the capsule 8220 may be removably sealed with the tab 8250. That is, instead of being sealed directly onto the housing 8110, the tab 8250 may be sealed onto the capsule 8220. The sealed capsule 8220 may be placed inside the liquid reservoir 8200. The capsule 8220 may be shaped to fit snugly inside and follow the contours of the liquid reservoir 8200 formed on the housing 8110. The capsule 8220 may include a lip 8221. The liquid reservoir 8200 or the housing 8110 may contain corresponding mating features, such as protrusions or detents, to facilitate coupling the liquid capsule 8220 with the liquid reservoir 8200. The lip 8221 may facilitate sealing the tab 8250 onto the capsule 8220.

The removable tab 8250 used to seal the liquid reservoir 8200 may include a first portion 8251 and a second portion 8252. The first portion 8251 may be a sealing portion disposed against (e.g., sealed onto) the lip 8221 (or the opening 8220 if the device 8100 does not include a capsule 8220). The second portion 8252 may extend out from the housing 8110 and may form a pull tab. A user may pull on the second portion 8252 to at least partially slide the tab 8250 from between the liquid reservoir 8200 (e.g., capsule 8220) and the porous sample collection media 8130 to create an opening in the liquid reservoir 8200 and to release the liquid.

The sample collection device 8100 may further include a heating system 8400 configured to heat a heatable reaction zone containing the porous sample collection media 8130. The heating system 8400 may include a resistive heating element or an inductive heating element. The heating system 8400 may include, for example, the heating system 410 of FIG. 8F.

The system 8001 further includes an assay 8300 for receiving the amplified sample to analyze the analyte of interest. The assay 8300 is housed within the housing 8110. The assay 8300 is positioned to receive a sample from the porous sample collection media 8130. The housing 8110 may include a viewing window 8270 that allows a user to view the result of the assay 8300.

A user may collect a sample by exhaling into the mouthpiece 8230 of the sample collection device 8100 to produce loaded sample collection media. The reagent composition may then be applied onto the loaded sample collection media from the liquid reservoir 8200. The heating system 8400 may be activated to heat the loaded sample collection media 8131 and the applied reagent composition to initiate the amplification reaction. The amplified sample may further be eluted or flown onto the assay 8300 for analysis.

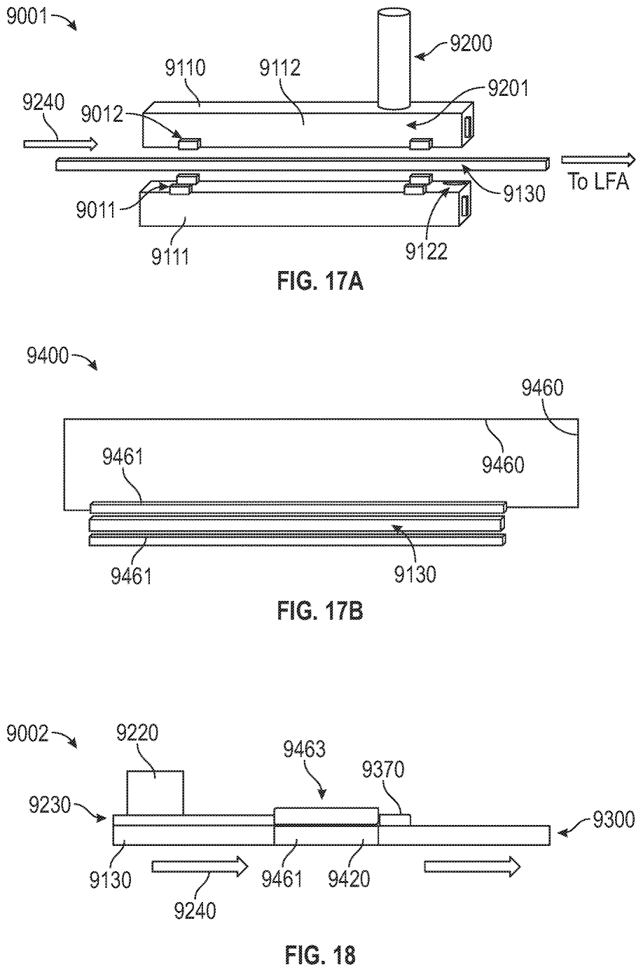

In some embodiments, illustrated in FIGS. 17A and 17B, the system 9001 includes a housing 9110 for the amplification system, which includes a liquid reservoir 9200 (including the reagent composition), a heatable reaction zone 9420, a heating system 9410. A loaded sample collection media 9130 may be placed into the housing 9110. The housing 9110 may have a two-part construction with a first portion 9111 and a second portion 9112. The first and second portions 9111, 9112 may be coupled together, for example, using interlocking teeth 9011, 9012. The loaded sample collection media 9130 may be sandwiched between the first and second portions 9111, 9112. Optionally, a buffer and/or primers may be applied onto the loaded sample collection media 9130 and may cause the captured sample to flow in the direction of arrow 9240, toward the liquid reservoir 9200. From the liquid reservoir 9200, reagents may be applied onto the sample to initiate the amplification reaction. Further reagents may be included in an interstitial space 9201 of the housing 9110 that may be flushed onto the sample collection media 9130 by the reagents in the liquid reservoir 9200. The system 9001 may further include a heating system 9400 (detail shown in FIG. 17B), configured to heat the sample on the sample collection media 9130. The heating system 9400 may include electrical connectors 9460 connecting heating elements 9461 (e.g., inductive or resistive heating elements) to a control system (not shown). The sample collection media 9130 may be disposed between the heating elements 9461. The heating system 9400 may include, for example, the heating system 410 of FIG. 8F.

In another embodiment shown in FIG. 18, the system 9002 includes a spacer 9230 that creates an airflow path and allows venting of exhaled breath through the sample collection media 9130. A liquid reservoir 9220 may be used to apply a reagent on the loaded sample collection media 9130. The reagent and sample may flow in the direction of arrow 9240 toward the heatable reaction zone 9420. The system 9002 may include a first heating element 9461 and an optional second heating element 9463, which may be provide an alternative heat source, such as solar. The system 9002 may further include a mechanism 9370 for moving the amplified sample onto an assay 9300.

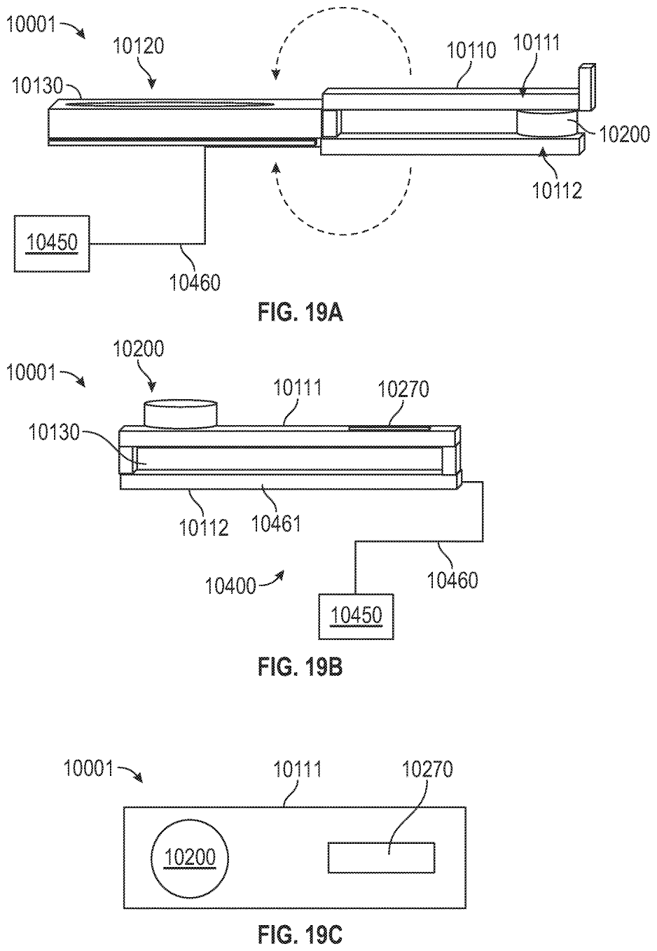

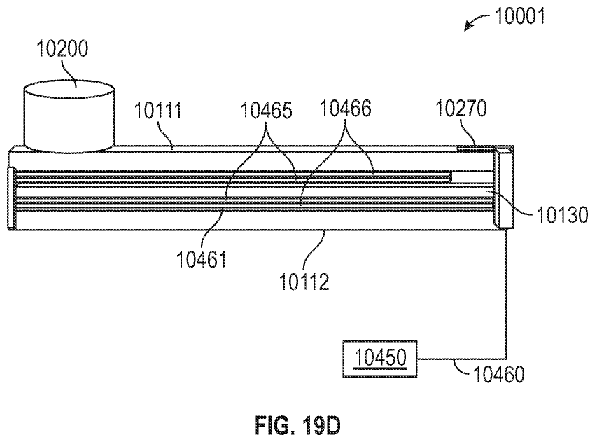

In an embodiment shown in FIGS. 19A-19D, the system 10001 includes a clam shell housing 10110. The clam shell housing 10110 may include a first portion 10111 and a second portion 10112. The first and second portions 10111, 10112 are shown in an open configuration in FIG. 19A and in a closed configuration in FIG. 19B. In the open configuration, an airflow path 10120 is open through the sample collection media 10130 provided in the housing 10110. In the closed configuration, a liquid reservoir 10200 is aligned with the sample collection media 10130 and is configured to provide a reagent solution onto the loaded sample collection media 10130. The housing 10110 (e.g., the second portion 10112) further includes a heating element 10461 connected to a controller 10450 via connecting line 10460, forming a heating system 10400. The heating system 10400 may include, for example, the heating system 410 of FIG. 8F. In an alternative embodiment shown in FIG. 19D, the heating element 100461 is provided with induction layers 10466. The system 10001 may further include heat dispersion layers 10465 between the induction layers 10466 and the sample collection media 10130. The clam shell housing 10110 may act as an insulating layer. The results (e.g., a color change) may be observed through a result window 10270.

The housing of any of the embodiments discussed above may be formed of a rigid material, such as plastic or a paper-based material such as cardboard or cardstock. In some embodiments, the housing is made of plastic. The housing may be made of a material that does not absorb any of the liquid or eluent. For example, the housing may be made of a hydrophobic material. In some embodiments, at least a portion of the housing is transparent. For example, the housing may include transparent material in an area of a result display of the assay. The housing may include a viewing window (either transparent material or an opening) in the area of the result display. In some cases, the entire housing may be made of a transparent material. The housing may further include a cover or sealing layer constructed to prevent contamination before or after use of the system. The cover or sealing layer may be removable (e.g., may be removed before use). The cover or sealing layer may be closable and/or re-closable (e.g., may be closed after use).

The sample collection device housing of any of the embodiments discussed above may include a pre-filter or screen disposed in the airflow path in front (upstream) of the porous sample collection media. The screen may be constructed to catch larger particles (larger than viruses or pathogens) and prevent such particles from reaching the porous sample collection media. The exhalation airflow passes through a thickness of the pre-filter or screen. The pre-filter or screen at least partially occludes the air flow path. In some cases, the pre-filter or screen may have a major plane that is orthogonal to the direction of the exhalation airflow passing through the thickness of the pre-filter or screen. The pre-filter or screen may be a non-woven layer configured to filter out larger particles from the exhalation airflow passing through the pre-filter or screen. In some cases, the pre-filter or screen may be a non-woven layer that does not have an electrostatic charge. In some embodiments, the pre-filter or screen does not capture significant amounts of viral material, pathogen material, or other analyte material, and instead allows them to transmit through the pre-filter or screen. In some embodiments, the pre-filter or screen is made of or includes at least one of a plastic mesh, a woven net, a needle-tacked fibrous web, a knitted mesh, an extruded net, and/or a carded or spunbond coverstock.

The user may exhale into the sample collection device and load the porous sample collection media with a sample of the exhalation airflow to form a loaded porous sample collection media. For example, the user may exhale through the air inlet or through the mouthpiece or nosepiece. The housing may be constructed such that by exhaling through the single opening, air inlet, mouthpiece, or nosepiece, the exhalation airflow passes through the porous sample collection media. The porous sample collection media is constructed to capture viruses, other pathogens, or other analytes, from the exhalation airflow. The user may then release a metered dose of liquid from the liquid reservoir to apply the liquid to the loaded porous sample collection media and to elute the captured sample onto the assay. The metered dose of liquid may include reagents forming a reagent composition. In some embodiments, at least some of the reagents are provided in dry (e.g., dry powder) form, and the user may mix the dry reagents with the metered dose of liquid. The user may activate the heating system to heat the porous sample collection media and the liquid to initiate the amplification reaction. The user may observe a color reaction of the amplified sample. The user may optionally test the amplified sample for the presence of a virus, pathogen, or other analyte using the assay. The testing may take place with the loaded porous sample collection media in place in the sample collection and analysis system.

Although the methods of using the sample collection and analysis devices described here refer to a single user, it is within the scope of this disclosure that samples from multiple users may be pooled and analyzed together as one sample. For example, the samples of the members of a family or other group of people could be pooled together to be analyzed as one sample. Samples may be pooled, for example, by combining multiple loaded sample collection media in a vessel (e.g., a tube) and eluting the samples together.

### EMBODIMENTS

The following is a list of exemplary embodiments according to the present disclosure.
Embodiment 1 is a sample collection and analysis system comprising:
   porous sample collection media;
   a liquid reservoir containing a liquid;
   a reagent composition; and
   a housing comprising:
      a heatable reaction zone; and
      a heating system operably coupled with the heatable reaction zone.
Embodiment 2 is the sample collection and analysis system of embodiment 1, wherein the heating system is constructed to heat the porous sample collection media and at least a portion of the reagent composition in the heatable reaction zone to a predetermined temperature of 37° C. to 70° C.
Embodiment 3 is the sample collection and analysis system of embodiment 2, wherein the predetermined temperature is 35° C. or greater, 37° C. or greater, 40° C. or greater, 45° C. or greater, 50° C. or greater, 55° C. or greater, 60° C. or greater, 62° C. or greater, or 65° C. or greater. The predetermined reaction temperature may be 75° C. or less, 70° C. or less, 68° C. or less, or 65° C. or less. The predetermined reaction temperature may be from 50° C. to 75° C., 55° C. to 70° C., 60° C. to 70° C., 58° C. to 65° C., or about 60° C.
Embodiment 4 is the sample collection and analysis system of any one of embodiments 1 to 3, wherein the heating system is constructed to maintain the predetermined temperature for 5 min or longer, 10 min or longer, 15 min or longer, 20 min or longer, 25 min or longer, or 30 min or longer. The heating system may be constructed to maintain the predetermined temperature for 120 min or shorter, 90 min or shorter, 60 min or shorter, 50 min or shorter, 45 min or shorter, 40 min or shorter, 35 min or shorter, or 30 min or shorter. In some embodiments, the heating system is constructed to maintain the predetermined temperature for 10 min to 90 min or 15 min to 45 min.
Embodiment 5 is the sample collection and analysis system of any one of embodiments 1 to 4, wherein the reagent composition comprises a loop-mediated isothermal amplification (LAMP) reagent.
Embodiment 6 is the sample collection and analysis system of any one of embodiments 1 to 5, wherein the reagent composition comprises a buffer, polymerase enzyme, nucleotides, and salts. Embodiment 7 is the sample collection and analysis system of embodiment 6, wherein the buffer comprises tris(hydroxymethyl)aminomethane, potassium acetate, magnesium acetate, tris-acetate, or a combination thereof.
Embodiment 8 is the sample collection and analysis system of embodiment 6, wherein the polymerase enzyme comprises a Bst DNA polymerase.
Embodiment 9 is the sample collection and analysis system of embodiment 6, wherein the nucleotides comprise dNTPs.
Embodiment 10 is the sample collection and analysis system of embodiment 6, wherein the salt comprises magnesium chloride, magnesium sulfate, potassium chloride, ammonium sulfate, or a combination thereof.
Embodiment 11 is the sample collection and analysis system of any one of embodiments 1 to 10, wherein the reagent composition comprises tris(hydroxymethyl)aminomethane, Bst DNA polymerase, dNTPs, magnesium sulfate, potassium chloride, ammonium sulfate, and a dye.
Embodiment 12 is the sample collection and analysis system of any one of embodiments 1 to 11, wherein the reagent composition comprises DNA primers, optionally wherein the reagent composition comprises two, three, four, five, six, seven, or eight DNA primers, preferably wherein the reagent composition comprises four DNA primers.
Embodiment 13 is the sample collection and analysis system of embodiment 12, wherein the DNA primers have an annealing temperature (T_{A}) of 50° C. or less, 52° C. or less, 54° C. or less, 56° C. or less, 58° C. or less, 60° C. or less, 62° C. or less, 64° C. or less, 66° C. or less, 68° C. or less, or 70° C. or less. A primer may have a T_{A} of 40° C. or more, 42° C. or more, 44° C. or more, 46° C. or more, 48° C. or more, 50° C. or more, 52° C. or more, or 54° C. or more. A primer may have a T_{A} of 40° C. to 70° C., such as 50° C. to 60° C. or 55° C. In some embodiments wherein multiple primers are used, each primer may have the same T_{A}. In some embodiments wherein multiple primers are used, the T_{A} of each primer may be independently selected. The T_{A} of all primers of the reagent composition may be within 10° C., within 8° C., within 6° C., within 4° C., or within 2° C. of one another.
Embodiment 14 is the sample collection and analysis system of any one of embodiments 1 to 13, wherein the reagent composition comprises a detergent, optionally wherein the detergent comprises Triton X-100.
Embodiment 15 is the sample collection and analysis system of any one of embodiments 1 to 14, wherein the porous sample collection media is disposed within the housing.
Embodiment 16 is the sample collection and analysis system of any one of embodiments 1 to 15, wherein the housing comprises an air inlet constructed to receive an exhalation airflow and an airflow path extending from the air inlet through the porous sample collection media.
Embodiment 17 is the sample collection and analysis system of any one of embodiments 1 to 16, further comprising a pre-filter fixed within the housing and along the airflow path and between the air inlet and the porous sample collection media.
Embodiment 18 is the sample collection and analysis system of any one of embodiments 1 to 17, wherein the housing comprises the liquid reservoir in fluid communication with the porous sample collection media, constructed to direct liquid onto the porous sample collection media, the liquid reservoir comprising a volume housing the liquid; and a release mechanism for releasing the liquid from the liquid reservoir.
Embodiment 19 is the sample collection and analysis system of embodiment 18, wherein the release mechanism comprises a breakable membrane.
Embodiment 20 is the sample collection and analysis system of embodiment 18, wherein the release mechanism comprises a removable tab sealing an opening of the liquid reservoir.
Embodiment 21 is the sample collection and analysis system of embodiment 18, wherein the release mechanism comprises a removable tab positioned between the liquid reservoir and the porous sample collection media.
Embodiment 22 is the sample collection and analysis system of any one of embodiments 1 to 21, wherein the heatable reaction zone comprises the porous sample collection media and is constructed to receive at least a portion of the liquid and the reagent composition.
Embodiment 23 is the sample collection and analysis system of any one of embodiments 1 to 22, wherein the housing comprises an assay constructed to receive a reaction mixture from the porous sample collection media.
Embodiment 24 is the sample collection and analysis system of embodiment 23, wherein the assay is constructed to detect presence of a virus, other pathogen, or other analyte in the reaction mixture.
Embodiment 25 is the sample collection and analysis system of embodiment 23, wherein the assay is a lateral flow assay, a vertical flow assay, or a colorimetric indicator.
Embodiment 26 is the sample collection and analysis system of embodiment 23, wherein the housing comprises a test result display window.
Embodiment 27 is the sample collection and analysis system of any one of embodiments 1 to 26, further comprising a colorimeter.
Embodiment 28 is the sample collection and analysis system of any one of embodiments 1 to 27, wherein the heating system comprises a resistive heating element or inductive heating element.
Embodiment 29 is the sample collection and analysis system of any one of embodiments 1 to 28, wherein the reagent composition comprises a first liquid reagent and a second liquid reagent.
Embodiment 30 is the sample collection and analysis system of embodiment 29, wherein the first liquid reagent comprises buffer, polymerase enzyme, nucleotides, and salts.
Embodiment 31 is the sample collection and analysis system of embodiment 30, wherein the first liquid reagent comprises tris(hydroxymethyl)aminomethane, Bst DNA polymerase, dNTPs, magnesium chloride, magnesium sulfate, potassium chloride, ammonium sulfate, and a dye.
Embodiment 32 is the sample collection and analysis system of embodiment 29, wherein the second liquid reagent comprises DNA primers.
Embodiment 33 is the sample collection and analysis system of embodiment 29, wherein the liquid reservoir contains the reagent composition.
Embodiment 34 is the sample collection and analysis system of embodiment 29, wherein the first liquid reagent is contained in a first compartment of the liquid reservoir and the second liquid reagent is contained in a second compartment of the liquid reservoir.
Embodiment 35 is the sample collection and analysis system of embodiment 29, further comprising a third liquid reagent.
Embodiment 36 is the sample collection and analysis system of embodiment 35, wherein the third liquid reagent comprises a detergent, such as Triton X-100.
Embodiment 37 is the sample collection and analysis system of embodiments 35 or 36, wherein the third liquid reagent is applied before the first liquid reagent and the second liquid reagent.
Embodiment 38 is the sample collection and analysis system of any one of embodiments 1 to 37, wherein the reagent composition comprises a dry lyophilized mixture.
Embodiment 39 is the sample collection and analysis system of embodiment 38, wherein the dry lyophilized mixture comprises a buffer, polymerase enzyme, nucleotides, salts, DNA primers, a dye, and an excipient.
Embodiment 40 is the sample collection and analysis system of embodiment 39, wherein the excipient comprises sugar, polyol, polymer, surfactant, chelating complex, or a combination thereof.
Embodiment 41 is the sample collection and analysis system of embodiment 38, wherein the reagent and the liquid are configured for mixing into a liquid reagent.
Embodiment 42 is the sample collection and analysis system of any one of embodiments 1 to 41, wherein the porous sample collection media defines a surface area and the liquid has a volume, and wherein the volume divided by the surface area is in a range from 10 μL/cm² to 400 μL/cm², or from 10 μL/cm² to 250 μL/cm².
Embodiment 43 is the sample collection and analysis system of any one of embodiments 1 to 42, wherein the liquid has a volume of 50 μL or greater, 100 μL or greater, 150 μL or greater, 200 μL or greater, or 250 μL or greater. The metered dose of liquid may have a volume of 1200 μL or less, 1000 μL or less, 750 μL or less, 500 μL or less, or 400 μL or less. The metered dose of liquid may have a volume of 50 μL to 1000 μL or 100 μL to 500 μL.
Embodiment 44 is the sample collection and analysis system of any one of embodiments 1 to 43, wherein the porous sample collection media comprises a nonwoven filtration layer having an electrostatic charge.
Embodiment 45 is the sample collection and analysis system of embodiment 44, wherein the nonwoven filtration layer is hydrophobic.
Embodiment 46 is the sample collection and analysis system of any one of embodiments 1 to 45, wherein the liquid comprises an aqueous solution comprising a surfactant.
Embodiment 47 is A method of collecting and testing a sample, the method comprising: flowing exhalation air through a porous sample collection media to form a captured sample; releasing a metered dose of liquid from a liquid reservoir and a reagent composition onto the captured sample; activating a heating system to heat the captured sample, the metered dose of liquid, and the reagent composition to a predetermined temperature of 37° C. to 70° C.; and observing a test result.
Embodiment 48 is the method of embodiment 47, wherein the reagent composition is mixed with the metered dose of liquid within the liquid reservoir.
Embodiment 49 is the method of embodiment 47 or 48, wherein the reagent composition is a dry powder and is mixed with the metered dose of liquid upon releasing of the metered dose of liquid and the reagent composition.
Embodiment 50 is the method of any one of embodiments 47 to 49, wherein the reagent composition comprises a first portion and a second portion and wherein the releasing of the reagent composition comprises mixing the first and the second portions.
Embodiment 51 is the method of any one of embodiments 47 to 50, wherein flowing exhalation air through the porous sample collection media comprises exhaling through a mouthpiece or a nosepiece.
Embodiment 52 is the method of any one of embodiments 47 to 51, wherein the porous sample collection media is disposed within a housing.
Embodiment 53 is the method of embodiment 52, wherein the housing comprises a heating system.
Embodiment 54 is the method of any one of embodiments 47 to 53, wherein the system further comprises an assay constructed to receive a reaction mixture from the porous sample collection media.
Embodiment 55 is the method of embodiment 54, wherein the method comprises reading the test result from the assay comprising an indicator of a presence of a virus, other pathogen, or other analyte in the reaction mixture.
Embodiment 56 is the method of any one of embodiments 47 to 55, wherein the method comprises reading the test result using a colorimeter.
Embodiment 57 is the method of any one of embodiments 47 to 56, wherein the observing of the test result comprises observing a positive result if a target virus or other target pathogen is present or negative result if a target virus or other target pathogen is absent.
Embodiment 58 is the method of any one of embodiments 47 to 57, wherein the heating system comprises using a resistive heating element or inductive heating element.
Embodiment 59 is the method of any one of embodiments 47 to 58, wherein the predetermined temperature is 35° C. or greater, 37° C. or greater, 40° C. or greater, 45° C. or greater, 50° C. or greater, 55° C. or greater, 60° C. or greater, 62° C. or greater, or 65° C. or greater. The predetermined reaction temperature may be 75° C. or less, 70° C. or less, 68° C. or less, or 65° C. or less. The predetermined reaction temperature may be from 50° C. to 75° C., 55° C. to 70° C., 60° C. to 70° C., 58° C. to 65° C., or about 60° C.
Embodiment 60 is the method of any one of embodiments 53 to 59, wherein the heating system is constructed to maintain the predetermined temperature for 5 min or longer, 10 min or longer, 15 min or longer, 20 min or longer, 25 min or longer, or 30 min or longer. The heating system may be constructed to maintain the predetermined temperature for 120 min or shorter, 90 min or shorter, 60 min or shorter, 50 min or shorter, 45 min or shorter, 40 min or shorter, 35 min or shorter, or 30 min or shorter. In some embodiments, the heating system is constructed to maintain the predetermined temperature for 10 min to 90 min or 15 min to 45 min.
Embodiment 61 is the method of any one of embodiments 47 to 60, wherein the reagent composition comprises a loop-mediated isothermal amplification (LAMP) reagent.
Embodiment 62 is the method of any one of embodiments 47 to 61, wherein the reagent composition comprises a buffer, polymerase enzyme, nucleotides, and salts.
Embodiment 63 is the method of embodiment 62, wherein the buffer comprises tris(hydroxymethyl)aminomethane, potassium acetate, magnesium acetate, tris-acetate, or a combination thereof.
Embodiment 64 is the method of embodiment 62, wherein the polymerase enzyme comprises a Bst DNA polymerase.
Embodiment 65 is the method of embodiment 62, wherein the nucleotides comprise dNTPs.
Embodiment 66 is the method of embodiment 62, wherein the salt comprises magnesium chloride, magnesium sulfate, potassium chloride, ammonium sulfate, or a combination thereof.
Embodiment 67 is the method of any one of embodiments 47 to 66, wherein the reagent composition comprises tris(hydroxymethyl)aminomethane, Bst DNA polymerase, dNTPs, magnesium sulfate, potassium chloride, ammonium sulfate, and a dye.
Embodiment 68 is the method of any one of embodiments 47 to 67, wherein the reagent composition comprises DNA primers, optionally wherein the reagent composition comprises two, three, four, five, six, seven, or eight DNA primers, preferably wherein the reagent composition comprises four DNA primers.
Embodiment 69 is the method of embodiment 68, wherein the DNA primers have an annealing temperature (T_{A}) of 50° C. or less, 52° C. or less, 54° C. or less, 56° C. or less, 58° C. or less, 60° C. or less, 62° C. or less, 64° C. or less, 66° C. or less, 68° C. or less, or 70° C. or less. A primer may have a T_{A} of 40° C. or more, 42° C. or more, 44° C. or more, 46° C. or more, 48° C. or more, 50° C. or more, 52° C. or more, or 54° C. or more. A primer may have a T_{A} of 40° C. to 70° C., such as 50° C. to 60° C. or 55° C. In some embodiments wherein multiple primers are used, each primer may have the same T_{A}. In some embodiments wherein multiple primers are used, the T_{A} of each primer may be independently selected. The T_{A} of all primers of the reagent composition may be within 10° C., within 8° C., within 6° C., within 4° C., or within 2° C. of one another.
Embodiment 70 is the method of any one of embodiments 47 to 69, wherein the reagent composition comprises a detergent, optionally wherein the detergent comprises Triton X-100.
Embodiment 71 is the method of any one of embodiments 52 to 70, wherein the porous sample collection media is disposed within the housing.
Embodiment 72 is the method of any one of embodiments 52 to 71, wherein the housing comprises an air inlet constructed to receive an exhalation airflow and an airflow path extending from the air inlet through the porous sample collection media.
Embodiment 73 is the method of any one of embodiments 52 to 72, further comprising a pre-filter fixed within the housing and along the airflow path and between the air inlet and the porous sample collection media.
Embodiment 74 is the method of any one of embodiments 52 to 73, wherein the housing comprises the liquid reservoir in fluid communication with the porous sample collection media, constructed to direct liquid onto the porous sample collection media, the liquid reservoir comprising a volume housing the liquid; and a release mechanism for releasing the liquid from the liquid reservoir, and wherein the method comprises activating the release mechanism.
Embodiment 75 is the method of embodiment 74, wherein the release mechanism comprises a breakable membrane.
Embodiment 76 is the method of embodiment 75, wherein the release mechanism comprises a removable tab sealing an opening of the liquid reservoir.
Embodiment 77 is the method of embodiment 76, wherein the release mechanism comprises a removable tab positioned between the liquid reservoir and the porous sample collection media.
Embodiment 78 is the method of any one of embodiments 47 to 77, wherein the reagent composition comprises a first liquid reagent and a second liquid reagent.
Embodiment 79 is the method of embodiment 78, wherein the first liquid reagent comprises buffer, polymerase enzyme, nucleotides, and salts.
Embodiment 80 is the method of embodiment 78, wherein the first liquid reagent comprises tris(hydroxymethyl)aminomethane, Bst DNA polymerase, dNTPs, magnesium chloride, magnesium sulfate, potassium chloride, ammonium sulfate, and a dye.
Embodiment 81 is the method of embodiment 78, wherein the second liquid reagent comprises DNA primers.
Embodiment 82 is the method of embodiment 78, wherein the liquid reservoir contains the reagent composition.
Embodiment 83 is the method of embodiment 82, wherein the first liquid reagent is contained in a first compartment of the liquid reservoir and the second liquid reagent is contained in a second compartment of the liquid reservoir.
Embodiment 84 is the method of embodiment 78, further comprising a third liquid reagent.
Embodiment 85 is the method of embodiment 84, wherein the third liquid reagent comprises a detergent, such as Triton X-100.
Embodiment 86 is the method of embodiments 84 or 85, wherein the third liquid reagent is applied before the first liquid reagent and the second liquid reagent.
Embodiment 87 is the method of any one of embodiments 47 to 86, wherein the reagent composition comprises a dry lyophilized mixture.
Embodiment 88 is the method of embodiment 87, wherein the dry lyophilized mixture comprises a buffer, polymerase enzyme, nucleotides, salts, DNA primers, a dye, and an excipient.
Embodiment 89 is the method of embodiment 88, wherein the excipient comprises sugar, polyol, polymer, surfactant, chelating complex, or a combination thereof.
Embodiment 90 is the method of embodiment 89, wherein the reagent and the liquid are configured for mixing into a liquid reagent.
Embodiment 91 is the method of any one of embodiments 47 to 90, wherein the porous sample collection media defines a surface area and the liquid has a volume, and wherein the volume divided by the surface area is in a range from 10 μL/cm² to 400 μL/cm², or from 10 μL/cm² to 250 μL/cm².
Embodiment 92 is the method of any one of embodiments 47 to 91, wherein the liquid has a volume of 50 μL or greater, 100 μL or greater, 150 μL or greater, 200 μL or greater, or 250 μL or greater. The metered dose of liquid may have a volume of 1200 μL or less, 1000 μL or less, 750 μL or less, 500 μL or less, or 400 μL or less. The metered dose of liquid may have a volume of 50 μL to 1000 μL or 100 μL to 500 μL.
Embodiment 93 is the method of any one of embodiments 47 to 92, wherein the porous sample collection media comprises a nonwoven filtration layer having an electrostatic charge.
Embodiment 94 is the method of embodiment 93, wherein the nonwoven filtration layer is hydrophobic.
Embodiment 95 is the method of any one of embodiments 47 to 94, wherein the liquid comprises an aqueous solution comprising a surfactant.

### EXAMPLES

TABLE 1
Reagents used in the Examples

| | Source |
|---|---|
| Reagent name | Cat. No. |
| Primers | Integrated DNA Technologies, |
| | Coralville, IA 100 nmol or |
| | 250 nmol DNA oligo |
| WarmStart Colorimetric | New England Biolabs, Ipswich, |
| LAMP 2X MasterMix | MA M1800 |
| (DNA & RNA) | |
| Water | Molecular grade water |
| Pseudomonas virus phi6 | DSMZ-German Collection of |
| | Microorganisms and Cell |
| | Cultures, Braunschweig, DE |
| | DSM-21518 |
| Pseudomonas sp. | DSMZ-German Collection of |
| | Microorganisms and Cell |
| | Cultures, Braunschweig, DE |
| | DSM-21482 |
| Tryptic soy broth | Fisher Scientific |
| | Difco DF0370 |

### Example 1

In this Example, loop-mediated isothermal amplification (LAMP) was used to detect known concentrations of dsDNA corresponding to 411 bases of the Pseudomonas virus phi6 bacteriophage genome.

A dsDNA fragment corresponding to a 411-nucleotide segment of the Pseudomonas virus phi6 segment S nucleocapsid gene corresponding to SEQ ID NO:9 was purchased from Integrated DNA Technologies, Coralville, IA. The dsDNA fragment reconstituted to a concentration of 1.13×10¹⁰ copies per μL. A serial dilution of dsDNA was prepared, resulting in seven sample concentrations as described in TABLE 2.

TABLE 2
dsDNA copies per μL and per reaction.

| Reaction No. | Phi6 dsDNA copies/μL | Phi6 dsDNA copies/reaction |
|---|---|---|
| 1 | 1.13 × 10⁷ | 56,500,000 |
| 2 | 1.13 × 10⁶ | 5,650,000 |
| 3 | 1.13 × 10⁵ | 565,000 |
| 4 | 1.13 × 10⁴ | 56,500 |
| 5 | 1.13 × 10³ | 5,650 |
| 6 | 1.13 × 10² | 565 |
| 7 | 1.13 × 10 | 57 |
| 8-16 | 0 | 0 |

Primers were designed to detect the phi6 segment S in a LAMP reaction (SEQ ID NO:1-8). A10× primer mix was prepared in water containing 16 μM LampF and LampB (SEQ ID NO:4 and SEQ ID NO:8), 2 μM DisF and DisB (SEQ ID NO:2 and SEQ ID NO:6), and 4 μM LoopF and LoopB (SEQ I DNO: 4 and SEQ ID NO:7).

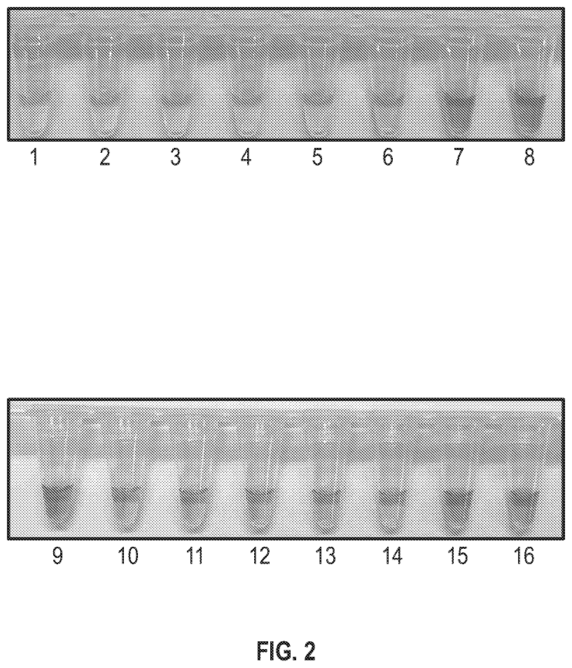

Each LAMP reaction was prepared using 12.5 μL of WarmStart Colorimetric LAMP 2× master mix, 2.5 μL 10× primer mix, 5 μL water, and 5 μL sample. Reactions were incubated at 65° C. for 30 minutes according to the manufacturer's recommended protocol. After 30 minutes, each reaction was visually analyzed for target detection, indicated by a change in the reaction color from pink to yellow. Images of each reaction are shown in FIG. 2. Yellow color was observed in reactions 1-6.

In this Example, it was learned that as little as 565 copies of Pseudomonas virus phi6 dsDNA could be detected colorimetrically using LAMP.

### Example 2

In this Example, LAMP was used to measure the concentration of Pseudomonas virus phi6 bacteriophage in media purified from Pseudomonas virus phi6 coculture with Pseudomonas sp. Protocols with and without heat, and with and without lysis buffer (0.1% Triton X-100, 20 mM Tris-HCl pH 7.5, 1 mM EDTA) were tested.

To prepare a phi6 stock, host (Pseudomonas sp.) culture was grown overnight in Tryptic Soy Broth with 5 mM MgSO4. The overnight host culture was used to inoculate fresh Tryptic Soy broth with and incubated for 2 hours at 37° C. with constant agitation at 120 RPM. After 2 hours, it was seeded with 2.5% v/v of Pseudomonas virus phi6 and allowed to propagate in the bacterial culture by continue incubation for additional 3 hours.

After incubation, the culture was centrifuged, and supernatant was filtered with a 0.2-μm-pore-size filter. The filtered supernatant is referred to herein as “Phi6 stock”. Phi6 stock titer was determined by plaque assay by combining 0.1 mL of host culture that had been incubated overnight, 100 μL of serially diluted phage, and 5 mL of soft agar. The mixture was poured onto Tryptic Soy agar plates, incubated at 26° C. for 24 hours. After incubation, plaque forming units (PFU) were quantified. The titer of the Phi6 stock was determined to be 10⁹ PFU/mL.

A 90 μL aliquot of Phi6 stock were mixed with 10 μL of lysis buffer to form a “Lysis” sample. A second 90 μL aliquot of Phi6 stock was mixed with 10 μL of lysis buffer and incubated at 100° C. for 10 minutes to form a “Heat+Lysis” sample. A third 90 μL aliquot of Phi6 stock was mixed with 10 μL of water to prepare a “No lysis” sample.

LAMP reactions were prepared as described in EXAMPLE 1 using WarmStart Colorimetric LAMP 2× master mix and 10× primer mix. For each sample, reactions were prepared in duplicate using different methods of sample delivery. 2 μL, or approximately 400,000 PFU, was used. 2 μL of each sample was spotted on 4 mm charged polylactic (PLA) nonwoven media coupons (Reactions 1-6), spotted on 3 mm PLA nonwoven media coupons (Reactions 7-12), spotted directly into strip tubes (Reactions 13-18), or added to the LAMP reaction directly (Reactions 19-24). Reactions 25-26 included 4 mm PLA punches spotted with water. Reactions 27-28 included 3 mm PLA punches spotted with water. Reactions 29-30 included 2 μL of water added to the LAMP reaction directly. All spotted samples were incubated at room temperature for 30 minutes before addition to the LAMP reaction.

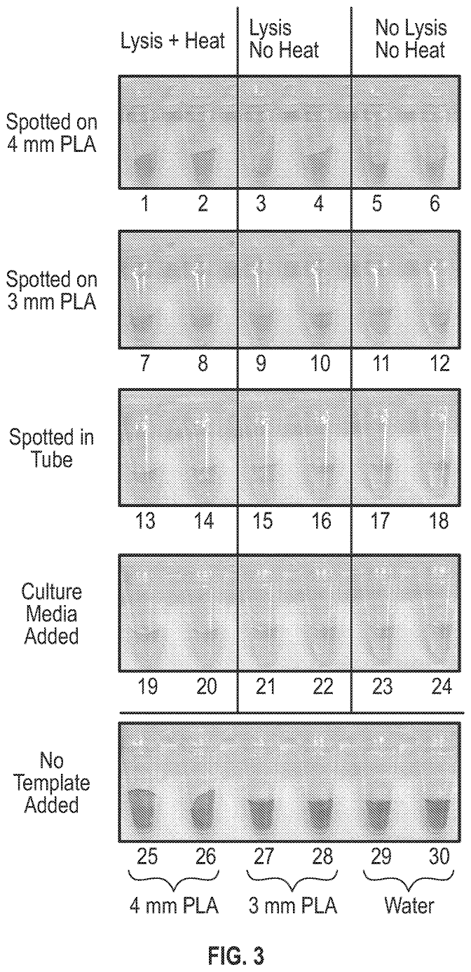

All reactions were incubated at 60° C. for 45 minutes. After incubation, each reaction was visually analyzed for a change in color indicating target detection. Images of each reaction are shown in FIG. 3. It was observed that all samples other than the non-template controls had changed to a yellow color, indicating that target had been detected.

From this Example, it was learned that at least 400,000 PFU Pseudomonas virus phi6 bacteriophage could be detected with or without lysis and/or heat from all sample delivery methods tested.

### Example 3

In this Example, LAMP was used to detect Pseudomonas virus phi6 in PLA nonwoven media treated with aerosolized phi6 stock.

Phi6 stock was prepared as described in EXAMPLE 2. Phi6 stock at a titer of approximately 10⁷ PFU/mL was aerosolized using a 6-jet Collison nebulizer (BGI Inc., Waltham, MA) operated at 20 psi under constant airflow rate of 40 L/min. Aerosolized suspension was applied to the charged PLA nonwoven media for 15 or 30 minutes. 4 mm coupons were punched from media treated for 15 and 30 minutes.

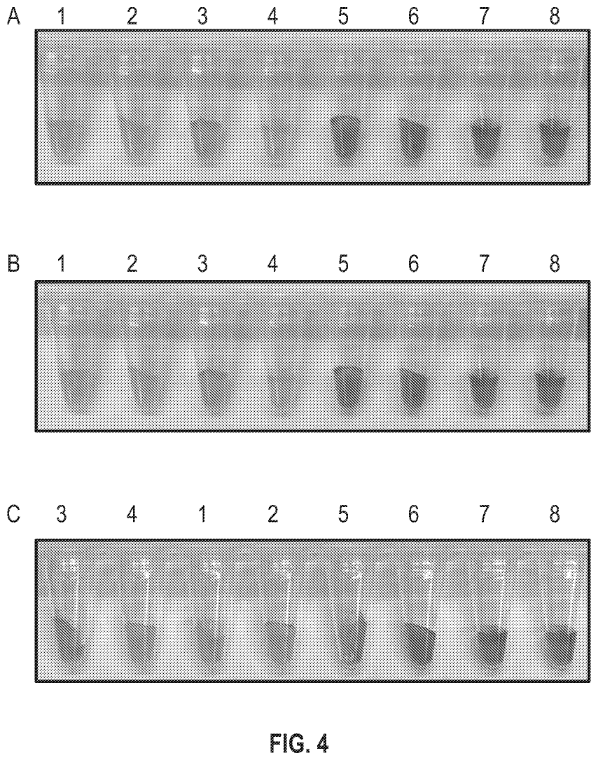

LAMP reactions were prepared as described in EXAMPLE 1. Reactions 1-2 included a 4 mm PLA coupon treated with aerosolized suspension for 15 minutes. Reactions 3-4 included a 4 mm PLA coupon treated with aerosolized suspension for 30 minutes. Reactions 5-6 included an untreated 4 mm PLA punch. Reactions 7-8 did not include PLA. All reactions were incubated at 60° C. for 45 minutes. After incubation, each reaction was visually analyzed for a change in color indicating target detection. Images of each reaction are shown in FIG. 4A. It was observed that the PLA punches exposed to aerosolized suspension for 15 or 30 minutes turned yellow, indication target detection. This reaction was repeated twice, images of the results from these replicates are shown in FIGS. 4B and 4C.

Two 4 mm PLA coupons punched from media treated for 15 minutes and two 4 mm PLA coupons punched from media treated for 30 minutes were used for RT-qPCR to quantify the number of copies of Phi6 present on each. cDNA was prepared using the Invitrogen SuperScript™ IV First-Strand Synthesis System (Thermo Fisher 18091050) using 5 μl of Phi6 suspension. Phi6 qPCR was performed using Agilent Brilliant III master mix (#600888) and primers and probes described in Turgeon N, Toulouse M J, Martel B, Moineau S, Duchaine C. Comparison of five bacteriophages as models for viral aerosol studies. Appl Environ Microbiol. 2014; 80(14):4242-4250. doi:10.1128/AEM.00767-14. Primer and probe final concentrations and sequences used were as follows: Φ6Tfor: 5′-TGGCGGCGGTCAAGAGC-3′ 0.5 μM, Φ6Trev: 5′-GGATGATTCTCCAGAAGCTGCTG-3′ 0.5 μM, @6Tprobe: 5′-FAM-CGGTCGTCGCAG GTCTGACACTCGC-BHQ-3′ 0.5 μM. Two microliters of cDNA were used for template. PCR cycling conditions were as follows: 10 min at 95° C., 40 cycles of 95° C. for 15 seconds and 57° C. for 1 min. Samples were tested by qPCR in duplicate. Standards were prepared using a serial dilution of the Pseudomonas virus phi6 dsDNA described in EXAMPLE 1 was prepared and used to calculate a standard curve for quantification of the Phi6 genome equivalents present on each coupon.

The coupons treated for 15 minutes were found to contain approximately 720 genome equivalents. The coupons treated for 30 minutes were found to contain approximately 8,500 genome equivalents.

From this Example, it was learned that Phi6 stock could be detected on 4 mM PLA coupons after treatment with aerosolized suspension for 15 minutes using colorimetric LAMP. It was also learned that approximately 720 genome copies could be detected using colorimetric LAMP.

### Example 4

In this Example, LAMP reactions with different reaction volumes were tested on 4 mm PLA coupons.

PLA nonwoven media was treated with aerosolized Phi6 stock for 30 minutes as described in EXAMPLE 3. After treatment, 4 mm coupons were punched from the media. Each coupon was added to a strip tube.

WarmStart Colorimetric LAMP 2× master mix, 2.5 μL and 10× primer mix were obtained as described in EXAMPLE 1. 1×LAMP reaction mix was prepared by combining 2× Warm Start LAMP reaction mix, 10× primer master mix, and water. Reactions were prepared according to Table 3. A second 1×LAMP reaction mix with Triton X-100 was prepared by combining WarmStart Colorimetric LAMP 2× master mix, 10× primer mix, and 0.5% Triton X-100. Reactions were prepared according to Table 3.

TABLE 3
Reaction components

| Reaction | Volume (μL) | Master Mix |
|---|---|---|
| 1 | 20 | 1X LAMP |
| 2 | 15 | 1X LAMP |
| 3 | 10 | 1X LAMP |
| 4 | 5 | 1X LAMP |
| 5 | 20 | 1X LAMP + 0.5% Triton X-100 |
| 6 | 15 | 1X LAMP + 0.5% Triton X-100 |
| 7 | 10 | 1X LAMP + 0.5% Triton X-100 |
| 8 | 5 | 1X LAMP + 0.5% Triton X-100 |

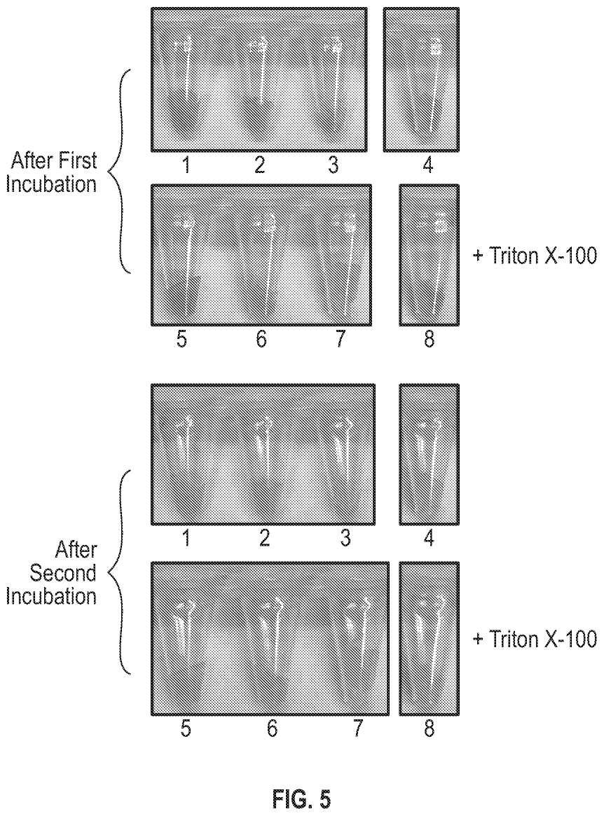

All reactions were incubated at 60° C. for 45 minutes. After incubation, each reaction was visually analyzed for a change in color indicating target detection. Images of each reaction are shown in FIG. 5. All reactions were the incubated for an additional 45 minutes at 60° C. Reactions were again visually analyzed for a charge in color. It was observed that reactions 1-3 and 5-7, corresponding to 20-10 μL reactions with or without Triton X-100, showed a yellow color change after the first 45-minute incubation. After the second 45-minute incubation, all reactions showed a yellow color, indicating target detection in all reaction conditions. Images of these results are shown in FIG. 5.

From this Example, it was learned that 10-20 μL LAMP reactions on PLA nonwoven media resulted in target detection of Phi6 after a first 45-minute incubation at 60° C. It was also learned that 5 μL LAMP reactions resulted in target detection after two 45-minute incubations at 60° C. It was learned that inclusion of 0.5% Triton X-100 did not significantly impact target detection.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A sample collection and analysis system comprising:
porous sample collection media;
a liquid reservoir containing a liquid;
a reagent composition; and
a housing comprising:
a heatable reaction zone; and
a heating system operably coupled with the heatable reaction zone.

2. The sample collection and analysis system of claim 1, wherein the heating system is constructed to heat the porous sample collection media and at least a portion of the reagent composition in the heatable reaction zone to a predetermined temperature of 37° C. to 70° C.

3. The sample collection and analysis system of claim 2, wherein the predetermined temperature is from 60° C. to 70° C.

4. The sample collection and analysis system of any one of claims 1 to 3, wherein the heating system is constructed to maintain the predetermined temperature for 5 minutes or longer.

5. The sample collection and analysis system of any one of claims 1 to 4, wherein the reagent composition comprises a loop-mediated isothermal amplification (LAMP) reagent.

6. The sample collection and analysis system of any one of claims 1 to 5, wherein the reagent composition comprises a buffer, polymerase enzyme, nucleotides, and salts.

7. The sample collection and analysis system of claim 6, wherein the buffer comprises tris(hydroxymethyl)aminomethane, potassium acetate, magnesium acetate, tris-acetate, or a combination thereof.

8. The sample collection and analysis system of claim 6, wherein the polymerase enzyme comprises a Bst DNA polymerase.

9. The sample collection and analysis system of claim 6, wherein the nucleotides comprise dNTPs.

10. The sample collection and analysis system of claim 6, wherein the salt comprises magnesium chloride, magnesium sulfate, potassium chloride, ammonium sulfate, or a combination thereof.

11. The sample collection and analysis system of any one of claims 1 to 10, wherein the reagent composition comprises tris(hydroxymethyl)aminomethane, Bst DNA polymerase, dNTPs, magnesium sulfate, potassium chloride, ammonium sulfate, and a dye.

12. The sample collection and analysis system of any one of claims 1 to 11, wherein the reagent composition comprises DNA primers.

13. The sample collection and analysis system of claim 12, wherein the DNA primers have an annealing temperature (T_{A}) of 50° C. to 60° C.

14. The sample collection and analysis system of any one of claims 1 to 13, wherein the reagent composition comprises a detergent, optionally wherein the detergent comprises Triton X-100.

15. The sample collection and analysis system of any one of claims 1 to 14, wherein the porous sample collection media is disposed within the housing.

16. The sample collection and analysis system of any one of claims 1 to 15, wherein the housing comprises an air inlet constructed to receive an exhalation airflow and an airflow path extending from the air inlet through the porous sample collection media.

17. The sample collection and analysis system of claim 16, further comprising a pre-filter fixed within the housing and along the airflow path and between the air inlet and the porous sample collection media.

18. The sample collection and analysis system of any one of claims 1 to 17, wherein the housing comprises the liquid reservoir in fluid communication with the porous sample collection media, constructed to direct liquid onto the porous sample collection media, the liquid reservoir comprising a volume housing the liquid; and a release mechanism for releasing the liquid from the liquid reservoir.

19. The sample collection and analysis system of claim 18, wherein the release mechanism comprises a breakable membrane.

20. The sample collection and analysis system of claim 18, wherein the release mechanism comprises a removable tab sealing an opening of the liquid reservoir.

21. The sample collection and analysis system of claim 18, wherein the release mechanism comprises a removable tab positioned between the liquid reservoir and the porous sample collection media.

22. The sample collection and analysis system of any one of claims 1 to 21, wherein the heatable reaction zone comprises the porous sample collection media and is constructed to receive at least a portion of the liquid and the reagent composition.

23. The sample collection and analysis system of any one of claims 1 to 22, wherein the housing comprises an assay constructed to receive a reaction mixture from the porous sample collection media.

24. The sample collection and analysis system of claim 23, wherein the assay is constructed to detect presence of a virus, other pathogen, or other analyte in the reaction mixture.

25. The sample collection and analysis system of claim 23, wherein the assay is a lateral flow assay, a vertical flow assay, or a colorimetric indicator.

26. The sample collection and analysis system of claim 23, wherein the housing comprises a test result display window.

27. The sample collection and analysis system of any one of claims 1 to 26, further comprising a colorimeter.

28. The sample collection and analysis system of any one of claims 1 to 27, wherein the heating system comprises a resistive heating element or inductive heating element.

29. The sample collection and analysis system of any one of claims 1 to 28, wherein the reagent composition comprises a first liquid reagent and a second liquid reagent.

30. The sample collection and analysis system of claim 29, wherein the first liquid reagent comprises buffer, polymerase enzyme, nucleotides, and salts.

31. The sample collection and analysis system of claim 30, wherein the first liquid reagent comprises tris(hydroxymethyl)aminomethane, Bst DNA polymerase, dNTPs, magnesium chloride, magnesium sulfate, potassium chloride, ammonium sulfate, and a dye.

32. The sample collection and analysis system of claim 29, wherein the second liquid reagent comprises DNA primers.

33. The sample collection and analysis system of claim 29, wherein the liquid reservoir contains the reagent composition.

34. The sample collection and analysis system of claim 29, wherein the first liquid reagent is contained in a first compartment of the liquid reservoir and the second liquid reagent is contained in a second compartment of the liquid reservoir.

35. The sample collection and analysis system of claim 29, further comprising a third liquid reagent.

36. The sample collection and analysis system of claim 35, wherein the third liquid reagent comprises a detergent, such as Triton X-100.

37. The sample collection and analysis system of claim 35 or 36, wherein the third liquid reagent is applied before the first liquid reagent and the second liquid reagent.

38. The sample collection and analysis system of any one of claims 1 to 37, wherein the reagent composition comprises a dry lyophilized mixture.

39. The sample collection and analysis system of claim 38, wherein the dry lyophilized mixture comprises a buffer, polymerase enzyme, nucleotides, salts, DNA primers, a dye, and an excipient.

40. The sample collection and analysis system of claim 39, wherein the excipient comprises a sugar.

41. The sample collection and analysis system of claim 38, wherein the reagent composition and the liquid are configured for mixing into a liquid reagent.

42. The sample collection and analysis system of any one of claims 1 to 41, wherein the porous sample collection media defines a surface area and the liquid has a volume, and wherein the volume divided by the surface area is in a range from 10 μL/cm² to 400 μL/cm², or from 10 μL/cm² to 250 μL/cm².

43. The sample collection and analysis system of any one of claims 1 to 42, wherein the liquid has a volume in a range of 50 μL to 1000 μL.

44. The sample collection and analysis system of any one of claims 1 to 43, wherein the porous sample collection media comprises a nonwoven filtration layer having an electrostatic charge.

45. The sample collection and analysis system of claim 44, wherein the nonwoven filtration layer is hydrophobic.

46. The sample collection and analysis system of any one of claims 1 to 45, wherein the liquid comprises an aqueous solution comprising a surfactant.

47. A method of collecting and testing a sample, the method comprising:
flowing exhalation air through a porous sample collection media to form a captured sample;
releasing a metered dose of liquid from a liquid reservoir and a reagent composition onto the captured sample;
activating a heating system to heat the captured sample, the metered dose of liquid, and the reagent composition to a predetermined temperature of 37° C. to 70° C.; and
observing a test result.

48. The method of claim 47, wherein the reagent composition is mixed with the metered dose of liquid within the liquid reservoir.

49. The method of claim 47 or 48, wherein the reagent composition is a dry powder and is mixed with the metered dose of liquid upon releasing of the metered dose of liquid and the reagent composition.

50. The method of any one of claims 47 to 49, wherein the reagent composition comprises a first portion and a second portion and wherein the releasing of the reagent composition comprises mixing the first and the second portions.

51. The method of any one of claims 47 to 50, wherein flowing exhalation air through the porous sample collection media comprises exhaling through a mouthpiece or a nosepiece.

52. The method of any one of claims 47 to 51, wherein the porous sample collection media is disposed within a housing.

53. The method of claim 52, wherein the heating system is comprised in the housing.

54. The method of any one of claims 47 to 53, wherein the system further comprises an assay constructed to receive a reaction mixture from the porous sample collection media.

55. The method of claim 54, wherein the method comprises reading the test result from the assay comprising an indicator of a presence of a virus, other pathogen, or other analyte in the reaction mixture.

56. The method of any one of claims 47 to 55, wherein the method comprises reading the test result using a colorimeter.

57. The method of any one of claims 47 to 56, wherein the observing of the test result comprises observing a positive result if a target virus or other target pathogen is present or negative result if a target virus or other target pathogen is absent.

58. The method of any one of claims 47 to 57, wherein the heating comprises using a resistive heating element or inductive heating element.


SEQUENCE LISTING (12 sequences)

SEQ ID NO: 1 - DNA, 19 bp, synthetic construct
  source 1..19: mol_type = other DNA
tactcctagcctggtttcc

SEQ ID NO: 2 - DNA, 16 bp, synthetic construct
  source 1..16: mol_type = other DNA
tcgtcgcaggtctgac

SEQ ID NO: 3 - DNA, 20 bp, synthetic construct
  source 1..20: mol_type = other DNA
acctctggatgattctccag

SEQ ID NO: 4 - DNA, 39 bp, synthetic construct
  source 1..39: mol_type = other DNA
gacaggtctttcagcatctgttatgacgcctatcagcag

SEQ ID NO: 5 - DNA, 20 bp, synthetic construct
  source 1..20: mol_type = other DNA
cattcagctgcattttcagg

SEQ ID NO: 6 - DNA, 17 bp, synthetic construct
  source 1..17: mol_type = other DNA
aggcgaatcaggttcga

SEQ ID NO: 7 - DNA, 20 bp, synthetic construct
  source 1..20: mol_type = other DNA
gatttcatcggtaacctcgg

SEQ ID NO: 8 - DNA, 35 bp, synthetic construct
  source 1..35: mol_type = other DNA
tcaaagccgacgaaatcccttcgaccagttccagc

SEQ ID NO: 9 - DNA, 411 bp, unidentified
  source 1..411: mol_type = genomic DNA; note = Pseudomonas virus phi6 bacteriophage genome segment
attgagagtgccattgcggctactcctagcctggtttcccgaatcgcagccgcgatcggttccaaggccagcccttccgccattttggcggcggtcaagagcaacccggtcgtcgcaggtctgacactcgctcagatcggaagcaccggttatgacgcctatcagcagcttctggagaatcatccagaggtcgccgagatgctgaaagacctgtctttcaaagccgacgaaatccagccggatttcatcggtaacctcggtcagtaccgcgaagagctggaactggtcgaagatgctgcccgcttcatgggcggcatgtcgaacctgattcgcctgcgccaggccctggaacttgatatcaagtactacggcctgaaaatgcagctgaatgacatgggataccgctcgtaa

SEQ ID NO: 10 - DNA, 17 bp, synthetic construct
  source 1..17: mol_type = other DNA
tggcggcggtcaagagc

SEQ ID NO: 11 - DNA, 23 bp, synthetic construct
  source 1..23: mol_type = other DNA
ggatgattctccagaagctgctg

SEQ ID NO: 12 - DNA, 25 bp, synthetic construct
  source 1..25: mol_type = other DNA
cggtcgtcgcaggtctgacactcgc